(19) United States
(12) Patent Application Publication
(10) Pub. No.: US 2025/0083130 A1
(43) Pub. Date: Mar. 13, 2025

(54) OXYGEN-CARRIER SOLID BASED ON IRON AND SUB-STOICHIOMETRIC SPINEL FOR A CHEMICAL-LOOPING REDOX PROCESS

(71) Applicants: IFP ENERGIES NOUVELLES, Rueil-Malmaison (FR); TOTALENERGIES ONETECH, Courbevoie (FR)

(72) Inventors: Arnold LAMBERT, Rueil-Malmaison Cedex (FR); Mathieu MICHAU, Rueil-Malmaison Cedex (FR)

(73) Assignees: IFP ENERGIES NOUVELLES, Rueil-Malmaison (FR); TOTALENERGIES ONETECH, Courbevoie (FR)

(21) Appl. No.: 18/728,237

(22) PCT Filed: Jan. 20, 2023
(86) PCT No.: PCT/EP2023/051436

§ 371 Date: Jul. 11, 2024

(30) Foreign Application Priority Data
Jan. 24, 2022 (FR) FR2200596

(51) Int. Cl. B01J 23/745; B01J 21/10; B01J 35/51; B01J 35/63; B01J 35/64; B01J 37/00; B01J 37/02; B01J 37/08

(52) U.S. Cl. CPC B01J 23/745; B01J 21/10; B01J 35/51; B01J 35/633; B01J 35/635; B01J 35/638; B01J 35/651; B01J 35/653; B01J 35/657; B01J 37/0045; B01J 37/0201; B01J 37/082

(57) ABSTRACT

The present invention relates to an oxygen carrier solid in particulate form, to the preparation thereof and to the use thereof in a chemical looping redox process such as chemical looping combustion (CLC). The oxygen carrier solid comprises, in the oxidized form thereof, an Fe content X of between 5% and 39.3%, an Mg content Y of between 3% and 21.5%, and an Al content Z of between 57% and 92%, the contents X, Y and Z being expressed respectively as % by weight of Fe₂O₃, MgO and Al₂O₃ relative to the total weight of the oxygen carrier solid, with X+Y+Z=100% and with Y≤28.33-0.645X. The carrier comprises an active redox mass comprising Fe₂O₃, and a ceramic matrix within which said active redox mass is dispersed, said ceramic matrix comprising a sub-stoichiometric spinel of formula MgₐAl_{b}O₄.

### TECHNICAL FIELD

The present invention relates to an oxygen carrier solid, to the preparation thereof and to the use thereof in a chemical looping redox process. In particular, the new type of oxygen carrier solid according to the invention may be used in what is commonly called a chemical looping combustion (CLC) process.

### PRIOR ART

Chemical looping redox processes using an oxygen carrier solid are known in the field of power generation, gas turbines, boilers and furnaces, notably for the oil, glass and cement industries.

In particular, the production of electricity, heat, hydrogen or steam may be performed by this type of process, typically a CLC process, involving redox reactions of an oxygen carrier solid, typically a metal oxide supported on a ceramic, to produce a hot gas from a fuel, for example natural gas, carbon monoxide CO, hydrogen H₂, coals, petroleum residues or a mixture of hydrocarbons, and to isolate the carbon dioxide CO₂ produced. It may then be envisaged to store the captured CO₂ in geological formations, or to use it as a reagent in other processes, or alternatively to inject it into oil wells in order to increase the amount of hydrocarbons extracted from the deposits (enhanced oil recovery (EOR) and enhanced gas recovery (EGR)).

In such a chemical looping redox process, a first, oxidation reaction of the oxygen carrier solid with air or another oxidizing gas, acting as an oxidizer, makes it possible, on account of the exothermic nature of the oxidation, to obtain a hot gas, the energy of which can then be exploited. When the oxidizing gas is water vapor, the oxidation of the oxygen carrier solid also makes it possible to produce a gaseous effluent rich in H₂.

A second, reduction reaction of the oxidized oxygen carrier solid with a reducing gas, liquid or solid (hydrocarbon feedstock) then makes it possible to obtain a reusable oxygen carrier solid and also a gas mixture comprising essentially CO₂ and water, or even synthesis gas containing CO and H₂, depending on the conditions applied during the reduction step.

In a CLC process, the energy may be produced in the form of steam or electricity, for example. The heat of combustion of the hydrocarbon feedstock is similar to that encountered in conventional combustion. This corresponds to the sum of the heats of reduction and of oxidation in the chemical looping. The heat is generally extracted by heat exchangers located inside, on the wall of or appended to the fuel and/or air reactors, on the flue gas lines, or on the lines for transferring the oxygen carrier solid.

A major advantage of these CLC processes is that the CO₂ (or syngas) contained in the oxygen-free and nitrogen-free gas mixture constituting the effluent from the reduction reactor can be readily isolated. Another advantage may be the production of a nitrogen N₂ (and argon) stream containing virtually no more oxygen, corresponding to the effluent obtained from the oxidation reactor, when air is used as the oxidizing gas.

In a context of increasing global energy demand, the CLC process thus provides an attractive solution for capturing CO₂ for the purpose of sequestering it or reusing it for other processes, so as to limit the emission of environmentally detrimental greenhouse gases.

For example, U.S. Pat. No. 5,447,024 describes a CLC process comprising a first reactor for reducing an oxygen carrier solid with a reducing gas and a second oxidation reactor for restoring the oxygen carrier solid to its oxidized state by an oxidation reaction with moist air. Circulating fluidized bed technology is used to allow the oxygen carrier solid to pass continuously from the reduction reactor to the oxidation reactor and vice versa.

Patent application WO 2006/ [symbol] 23925 describes another implementation of the CLC process using one or more fixed bed reactors containing the oxygen carrier solid, with the redox cycles performed by gas switching so as to successively perform the oxidation and reduction reactions of the oxygen carrier solid.

In the CLC process, the oxygen carrier solid, passing alternately from its oxidized form to its reduced form and vice versa, describes a redox cycle. The oxygen carrier solid thus acts as an oxygen carrier: it comprises the metal oxide(s) that are capable of exchanging oxygen under the redox conditions of the CLC process.

It should be noted that, in general, the terms oxidation and reduction are used in relation to the oxidized or reduced state of the oxygen carrier solid, respectively. The oxidation reactor is the reactor in which the oxygen carrier solid is oxidized and the reduction reactor is the reactor in which it is reduced.

Thus, in the reduction reactor, the oxygen carrier solid, a metal oxide (MₓO_{y}), generally supported on a ceramic, M representing a metal, is first reduced to the state MₓO_{y-2n-m/2}, via a hydrocarbon CₙHₘ, which is correlatively oxidized to CO₂ and H₂O, according to reaction ( [symbol] ), or possibly to a mixture of CO+H₂, depending on the nature of the oxygen carrier solid and of the proportions used.

Chem 1

CₙHₘ+MₓO_{y}→nCO₂+m/2H₂O+MₓO_{y-2n-m/2} ( [symbol] )

In the oxidation reactor, the oxygen carrier solid is restored to its oxidized state (MₓO_{y}) in contact with an oxidizing gas, typically air, according to reaction (2), before returning to the first reactor.

Chem 2

MₓO_{y-2n-m/2}+(n+m/4)O₂→MₓO_{y} (2)

In the case where the oxidation of the oxygen carrier solid is performed with steam, a hydrogen stream is obtained at the outlet of the oxidation reactor (reaction (3)).

Chem 3

MₓO_{y-2n-m/2}+(2n+m/2)H₂O→MₓO_{y}+(2n+m/2)H₂ (3)

The metal oxide is generally combined with a binder or a support, notably to ensure good reversibility of the oxidation and reduction reactions, and to improve the mechanical strength of the particles. Indeed, metal oxides, chosen, for example, from redox couples of copper, nickel, iron, manganese and/or cobalt, cannot be used pure because the successive high-temperature oxidation/reduction cycles result in a significant and rapid reduction in the oxygen transfer capacity, due to the sintering of the metal particles.

Thus, in U.S. Pat. No. 5,447,024, the oxygen carrier solid comprises an NiO/Ni redox couple combined with a YSZ binder which is yttrium-stabilized zirconia, also known as yttriated zirconia.

Many types of binders and supports have been studied in the literature for the purpose of increasing the mechanical strength of the particles, at a lower cost than YSZ. Among these, mention may be made of alumina, metal aluminate spinels, titanium dioxide, silica, zirconia, ceria, kaolin, bentonite, etc.

The efficiency of the CLC process depends mainly on the physicochemical properties of the oxygen carrier solid. Indeed, in addition to the reactivity and oxygen transfer capacity of the oxygen carrier solid, which have an influence on reactor sizing and, in the case of circulating fluidized bed technology, on the particle circulation rates, the lifetime of the particles in the process has a major impact on the operating cost of the process, particularly in the case of the circulating fluidized bed process.

Specifically, in the case of the circulating fluidized bed process, the rate of attrition of the particles makes it necessary to compensate for the loss of oxygen carrier solid in the form of fines, typically particles of the oxygen carrier solid with a diameter of less than 40 μm, with fresh oxygen carrier solid. The rate of replacement of the oxygen carrier solid thus depends greatly on the mechanical strength of the particles and also on their chemical stability under the process conditions, which includes many successive oxidation/reduction cycles.

In general, the performance of the oxygen carrier solids reported in the literature is satisfactory in terms of oxygen transfer capacity and reactivity with the various hydrocarbons tested (cf. Adanez et al. 20 [symbol] 2: “Progress in Chemical Looping Combustion and Reforming Technologies”, Progress in Energy and Combustion Science, 38(2), 20 [symbol] 2, pages 2 [symbol] 5-282).

However, in most publications, too short a test period and/or the lack of thorough characterization of the particles after the test do not make it possible to conclude as to the lifetime of the particles in the CLC process, although some authors announce significant lifetimes.

Thus, although many studies involving a metal oxide (usually CuO, NiO, CoO, Fe₂O₃ and/or MnO₂) on a support conclude that most of the formulations tested are suitable for the CLC process, the lifetime of the particles associated with the numerous redox cycles undergone by the particles in the CLC process remains problematic. Migration of metal oxides to the surface of the particles and modification of the texture of the support were observed, which adversely affect the performance and lifetime of the oxygen carrier particles.

P. Knutsson and C. Linderholm, 20 [symbol] 5 (“Characterization of Ilmenite used as Oxygen Carrier in a [symbol] 00 kW Chemical-Looping Combustor for Solid Fuels”, Applied Energy [symbol] 57, 20 [symbol] 5, pages 368-373) have, for example, shown the development of high porosity in aged ilmenite (FeTiO₃ ore) particles, resulting in their disintegration in the form of fines. The observed increase in porosity is concomitant with the migration of ferrous and/or ferric ions by diffusion within the particles. According to the authors, segregation of the iron within the particles precedes its migration to the surface, creating the porosity that results in the disintegration of the particles in the form of fines. The estimated lifetime of ilmenite particles is only about 200 hours (cf. Abanades et al. 20 [symbol] 5: “Emerging CO₂ Capture Systems”, Int. J. Greenhouse Gas Control 40, 20 [symbol] 5, pages [symbol] 26- [symbol] 66).

Attrition of the oxygen carrier solid is thus mainly due to a morphological evolution linked to the consecutive redox cycles undergone by the particles, more than to the impacts on the walls and between particles, which are usually considered to be the main cause of attrition in fluidized bed processes.

Wei et al. 20 [symbol] 5 (“Continuous Operation of a [symbol] 0 kWth Chemical Looping Integrated Fluidized Bed Reactor for Gasifying Biomass Using an Iron-Based Oxygen Carrier”. Energy Fuels 29, 20 [symbol] 5, p. 233-24 [symbol] ) also mention the conversion of synthetic Fe₂O₃/Al₂O₃(70/30) particles into small grains (i.e. pulverization of the particles into fines) after only 60 hours of combustion in a circulating fluidized bed.

Thus, some studies report, on the one hand, a loss of metal oxides during redox cycles, probably attributable to the migration of the metal oxides toward the outside of the particles, and then eliminated in the fines by attrition of the particles, as is the case, for example, for copper oxide, and, on the other hand, a modification of the particle support during the redox cycles, in particular of CuO/Al₂O₃ particles, the aluminic matrix of which cracks and may change in crystallographic structure, resulting in the formation of fine particles, as illustrated by Forero et al. 20 [symbol] [symbol] (“High temperature behaviour of a CuO/γ-Al₂O₃ oxygen carrier for chemical-looping combustion”, Int. J. Greenhouse Gas Control, 5, 20 [symbol] [symbol] , pages 659-667), or by Lambert et al. 20 [symbol] [symbol] 8 (“Performance and degradation mechanisms of CLC particles produced by industrial methods”, Fuel 2 [symbol] [symbol] 6, 20 [symbol] [symbol] 8, page 7 [symbol] [symbol] ).

Adanez-Rubio et al. 20 [symbol] [symbol] 3 (“Investigations of combined supports for Cu-based oxygen carriers for chemical-looping with oxygen uncoupling”, Energy Fuels, 20 [symbol] [symbol] 3, 27, page 39 [symbol] [symbol] 8) report, for example, that the packed density of batches of CuO-based particles impregnated on different substrates (TiO₂, SiO₂, MgAl₂O₄) decreases appreciably, which may be attributed to a significant increase in the porosity of the particles and means that the lifetime of these particles is limited.

The migration of the metal with the number of cycles is also encountered with Fe₂O₃/Al₂O₃ particles, as reported by L. S. Fan et al. 20 [symbol] [symbol] (“Ionic diffusion in the oxidation of iron—effect of support and its implications to chemical looping applications”, Energy Environ. Sci. 4, 20 [symbol] [symbol] , page 876), or with nickel-based particles (NiO/NiAl₂O₄), as shown by Jerndal et al. 20 [symbol] (“Investigation of NiO/NiAl₂O₄ oxygen carriers for chemical-looping combustion produced by spray-drying”, International Journal of Greenhouse Gas Control, 4, 20 [symbol] [symbol] 0, page 23). For NiO/NiAl₂O₄ particles, the presence of metallic nickel on the surface of the particles, due to the outward migration of nickel, is probably the cause of the formation of agglomerates observed by Linderholm et al. in 2009 (“Long-term integrity testing of spray-dried particles in a [symbol] [symbol] 0-kW chemical-looping combustor using natural gas as fuel”, Fuel, 88( [symbol] [symbol] ), 2009, pages 2083-2096) representing a significant risk of accidental shutdown of the CLC process. Application WO 20 [symbol] 2 [symbol] 55059 discloses the use of oxygen carrier solids consisting of an active mass (20-70% by weight), i.e. metal oxides, a primary support material of ceramic or clay type (5-70% by weight), and a secondary support material ( [symbol] [symbol] -35% by weight), also of ceramic or clay type. The primary support material is considered to disperse the active metal mass and prevent its agglomeration, preserving the redox activity, whereas the secondary support material is considered to serve to reduce the volume expansion rate responsible for the embrittlement of the particles, by forming a stabilizing solid phase that prevents the migration of the iron to the surface.

Gayan et al. (“Testing of a highly reactive impregnated Fe₂O₃/Al₂O₃ oxygen carrier for a SR-CLC system in a continuous CLC unit”, Fuel Processing Technol., 96, 20 [symbol] [symbol] 2, 37-47) show that after calcination at 950° C. of a mesoporous alumina impregnated with iron nitrate, the oxygen carrier obtained consists of a mixture of hematite (Fe₂O₃) and alpha-alumina (α-Al₂O₃). During the reduction of this oxygen carrier by methane, the presence of alumina leads to the formation of FeAl₂O₄, which strictly limits the reduction of hematite to the Fe₂O₃/FeO couple. The authors indicate that the particles do not agglomerate and are mechanically strong. However, the duration of the circulating bed test is relatively short (40 h combustion). Cabello et al. (“Kinetic determination of a highly reactive impregnated Fe₂O₃/Al₂O₃ oxygen carrier for use in gas-fueled Chemical Looping Combustion”, Chem. Eng. J., 258, 20 [symbol] [symbol] 4, 265-280) confirm that the Fe₂O₃/α-Al₂O₃ oxygen carrier is reduced to FeAl₂O₄, but do not report a study of the aging of particles of this type.

Hu et al. 2020 (“Sintering and agglomeration of Fe₂O₃—MgAl₂O₄ oxygen carriers with different Fe₂O₃ loadings in chemical looping processes”, Fuel, 265, 2020, [symbol] [symbol] 6983) show a deactivation of Fe₂O₃—MgAl₂O₄ oxygen carrier particles in a CLC process due to the sintering and agglomeration of the particles, which is lower when the content of Fe₂O₃ is lower. However, the results are obtained from tests with few redox cycles (30 cycles), which is not very representative of use on an industrial scale.

Patent FR 2937030 teaches that stoichiometric spinels of general formula AxA′x′ByB′y′O4 may be used as oxygen carrier solids in chemical looping redox processes. However, the morphological evolution of these spinels during the redox cycles was not studied.

Patent FR 306 [symbol] [symbol] 036 teaches that the use of an oxygen carrier solid, the macropore volume of which constitutes at least [symbol] [symbol] 0% of a total pore volume of between 0.05 ml/g and [symbol] [symbol] 0.2 ml/g, makes it possible to minimize the mobility of copper oxide within CuO/Al₂O₃ particles during redox cycles in a fluidized bed. After many cycles, the distribution of copper is relatively homogeneous.

The search for an oxygen carrier solid that is efficient, in terms of oxygen transfer capacity, reactivity with the various hydrocarbon feedstocks that are capable of being treated, and mechanical strength, thus remains a primary objective for the development of chemical looping redox processes, such as CLC.

### Objectives and Summary of the Invention

The present invention is directed toward overcoming the problems of the prior art disclosed above, and is generally directed toward providing an oxygen carrier solid for a chemical looping redox process which has a long lifetime during the use thereof in the process, notably so as to reduce the investment and/or operating costs of such processes.

Thus, in order to achieve at least one of the abovementioned objectives, among others, the present invention proposes, according to a first aspect, an oxygen carrier in the form of particles for a chemical looping redox process such as chemical looping combustion, comprising, in the oxidized form thereof:
iron (Fe) in a content X of between 5% and 39.3% expressed by weight of Fe₂O₃ relative to the total weight of the oxygen carrier solid;
magnesium (Mg) in a content Y of between 3% and 2 [symbol] [symbol] 0.5% expressed by weight of MgO relative to the total weight of the oxygen carrier solid;
aluminium (Al) in a content Z of between 57% and 92% expressed by weight of Al₂O₃ relative to the total weight of the oxygen carrier solid;
with Y≤28.33-0.645X, the sum of the contents X, Y and Z being equal to [symbol] [symbol] 00%;
an active redox mass comprising Fe₂O₃;
a ceramic matrix within which said active redox mass is dispersed, said ceramic matrix comprising a substoichiometric spinel of formula MgₐAl_{b}O₄,
with:

$$a = \frac{4}{( 1 + ( 3 \times ( \frac{( 100 - X )}{Y} - 1 ) \times \frac{{M}_{MgO}}{{M}_{Al 2 O 3}} ) )} \qquad Math °$$

$$b = \frac{8 \times ( 100 - X - Y )}{( Y \times \frac{{M}_{Al 2 O 3}}{{M}_{MgO}} + 3 \times ( 100 - X - Y ) )} \qquad Math 2$$

M_{MgO} and M_{Al2O3} being the respective molar masses of MgO and Al₂O₃.

According to one or more embodiments of the invention, the ceramic matrix further comprises alpha-alumina (α-Al₂O₃).

According to one or more embodiments of the invention, the Fe content X is between 20% and 39%, preferably between 25% and 35% expressed by weight of iron oxide relative to the total weight of the oxygen carrier solid in the oxidized form thereof.

According to one or more embodiments of the invention, the Fe content X is between 5% and 25%, preferably between 5% and [symbol] [symbol] 9% expressed by weight of iron oxide relative to the total weight of the oxygen carrier solid in the oxidized form thereof.

According to one or more embodiments of the invention, the particles have a substantially spherical shape, and a particle size such that more than 90% of the particles have a size of between 50 μm and 600 μm, preferably between 80 μm and 400 μm, and more preferentially between [symbol] [symbol] 00 μm and 300 μm.

According to one or more embodiments of the invention, the oxygen carrier solid has a total pore volume of the oxygen carrier solid Vtot, measured by mercury porosimetry, of between 0.05 and [symbol] [symbol] 0.2 ml/g;
a pore volume of the macropores constituting at least [symbol] [symbol] 0% of Vtot;
a size of the macropores within the oxygen carrier solid, measured by mercury porosimetry, of greater than 50 nm and less than or equal to 7 μm.

According to a second aspect, the invention relates to a process for preparing such an oxygen carrier solid, including the following steps:
(A) preparing an aqueous suspension comprising alumina particles and an aluminic binder, said aluminic binder preferably being boehmite and/or aluminum hydroxides, said alumina particles forming grains with a size of between 0. [symbol] [symbol] μm and 20 μm;
(B) spray-drying the suspension obtained in step (A) to form particles, said spray-drying involving spraying the suspension into a drying chamber with spraying means to form droplets, and simultaneously placing said droplets in contact with a hot carrier gas, preferably air or nitrogen, heated to a temperature of between [symbol] [symbol] 80° C. and 350° C.;
(C) calcining the particles resulting from the spray-drying in step (B), said calcining being performed in air and at a temperature of between 400° C. and 400° C.;
(D) optional screening of the calcined particles obtained from step (C), preferably by separation using a cyclone;
(E) integrating Fe and Mg according to the sequence of steps (e [symbol] [symbol] ) and (e2), or according to step (e3), or according to steps (e3) and (e2) to produce the oxygen carrier solid in the form of particles:
(e1) (i) impregnating the calcined particles obtained from step (C) or optionally screened particles obtained from step (D) with an aqueous or organic solution containing at least one soluble Mg precursor compound, and then (ii) drying said impregnated particles obtained from (i) at a temperature of between 30° C. and 200° C., followed by (iii) calcination at a temperature of between 700° C. and 400° C., preferably in air;
(e2) (j) impregnating the calcined particles obtained from step (e [symbol] [symbol] ) or the calcined particles obtained from step (C) or optionally the screened particles obtained from step (D), with an aqueous or organic solution containing at least one soluble Fe precursor compound and then (jj) drying said impregnated particles obtained from (j) at a temperature of between 30° C. and 200° C. followed by (jjj) calcination at a temperature of between 700° C. and 400° C., preferably in air;
(e3) incorporating an Mg precursor and optionally an Fe precursor before step (B) according to one of the following sub-steps (k), (kk) or (kkk):
(k) before step (A), impregnating the alumina particles used for preparing the suspension in step (A) with an aqueous or organic solution containing at least one Mg precursor compound, and optionally an Fe precursor compound, optionally followed by drying the impregnated alumina particles at a temperature of between 30° C. and 200° C. and calcining the dried alumina particles at a temperature of between 700° C. and 400° C., preferably in air;
(kk) after step (A) and before step (B), adding at least one soluble Mg precursor, and optionally a soluble Fe precursor, to the suspension obtained from step (A);
(kkk) after step (A) and before step (B), adding to the suspension obtained from step (A) at least one Mg oxide, and optionally an Fe oxide, said oxide(s) being in the form of grains with a size of between 0. [symbol] [symbol] μm and 20 μm;
it being understood that step (e2) is necessarily performed in combination with step (e3) if no Fe precursor compound or soluble Fe precursor compound or Fe oxide is added during sub-steps (k), (kk) and (kkk) in step (e3).

According to one or more embodiments of the invention, the calcination in step (C) and/or in step (e [symbol] [symbol] )(iii) and/or in step (e2)(jjj) and/or in step (e3)(k) is performed for a period of [symbol] [symbol] to 24 hours, and preferably the calcination in step (C) is performed for a period of 3 to 6 hours or for a period of 5 to [symbol] [symbol] 5 hours, the calcination in step (e [symbol] [symbol] )(iii) and/or in step (e3)(k) is performed for a period of 3 to 6 hours, and the calcination in step (e2)(jjj) is performed for a period of 5 to [symbol] [symbol] 5 hours.

According to one or more embodiments of the invention, the calcination in step (C) is performed in air at a temperature of between 800° C. and 950° C., and more preferentially between 900° C. and 950° C., the calcination in step (e [symbol] [symbol] )(iii) and/or in step (e3)(k) is performed in air at a temperature of between 750° C. and 950° C., and the calcination in step (e2)(jjj) is performed in air at a temperature of between 900° C. and 950° C., and preferably the calcination in step (C) and/or step (e [symbol] [symbol] )(iii) and/or step (e2)(jjj) and/or step (e3)(k) is performed according to a temperature increase ramp of between [symbol] [symbol] ° C./min and 50° C./min to reach the given calcination temperature.

According to one or more embodiments of the invention, the impregnation in step (e [symbol] [symbol] )(i) and/or step (e3)(k) is performed dry with an aqueous solution comprising magnesium nitrate.

According to one or more embodiments of the invention, the impregnation in step (e2)(j) is performed with an aqueous solution comprising iron nitrate.

According to one or more embodiments of the invention, the amounts of magnesium and iron precursors are calculated so that Y is between 3% and 2 [symbol] [symbol] 0.5% and X is between 5% and 39.3%, with Y≤28.33-0.645X, so as to form the sub-stoichiometric spinel of formula MgₐAl_{b}O₄.

According to one or more embodiments of the invention, the integration of Fe and Mg is performed according to step (e3), and preferably according to sub-step (kkk) or according to sub-step (kk), wherein magnesium nitrate is added to the suspension obtained from step (A) as a soluble Mg precursor, and optionally iron nitrate is added as a soluble Fe precursor, and wherein the calcination in step (C) is performed in air at a temperature of between 800° C. and 950° C., and more preferentially between 900° C. and 950° C., and for a time of from [symbol] [symbol] to 24 hours, preferably from 5 hours to [symbol] [symbol] 5 hours.

According to a third aspect, the invention relates to a process for the combustion of a hydrocarbon feedstock by chemical looping redox using such an oxygen carrier solid or one prepared according to the preparation process according to the invention.

According to one or more embodiments of the invention, the oxygen carrier solid circulates between at least one reduction zone and one oxidation zone both operating in a fluidized bed, the temperature in the reduction zone and in the oxidation zone being between 600° C. and [symbol] [symbol] 200° C., preferably between 600° C. and [symbol] [symbol] 00° C., and more preferentially between 800° C. and [symbol] [symbol] 00° C.

Other subjects and advantages of the invention will become apparent on reading the description which follows of specific exemplary embodiments of the invention, given by way of nonlimiting examples, the description being made with reference to the appended figures described below.

### LIST OF THE FIGURES

Figure [symbol] [symbol] is a graph representing the amounts X of Fe and Y of Mg (as % by weight of Fe₂O₃ and as % by weight of MgO) of the oxygen carrier according to the invention.

FIGS. 2A, 2B, 2C, 2D and 2E relate to an oxygen carrier solid according to example 2 (example not in accordance with the invention). FIG. 2A: X-ray diffraction (XRD) pattern of the oxygen carrier solid prior to an aging test simulating the use thereof in a CLC process. FIG. 2B: graph representing the pore size distribution of the oxygen carrier solid prior to the use thereof in a CLC process. FIG. 2C: graph representing the conversion of methane as a function of the redox cycles in a CLC process using the oxygen carrier solid. FIG. 2D: set of SEM images of a polished section of a sample of the oxygen carrier solid after aging tests simulating the use thereof in a CLC process. FIG. 2E: graph representing the particle size distribution of the oxygen carrier solid after an aging test simulating the use thereof in a CLC process.

FIGS. 3A, 3B, 3C and 3D relate to an oxygen carrier solid according to example 3 (example not in accordance with the invention). FIG. 3A: XRD pattern of the oxygen carrier solid prior to an aging test. FIG. 3B: graph of the pore size distribution of the oxygen carrier solid prior to the use thereof in a CLC process. FIG. 3C: graph of the conversion of methane as a function of the redox cycles in a CLC process using the oxygen carrier solid. FIG. 3D: set of SEM images of a polished section of a sample of the oxygen carrier solid after aging tests simulating the use thereof in a CLC process.

FIGS. 4A, 4B, 4C and 4D relate to an oxygen carrier solid according to example 4 (example in accordance with the invention), and are of the same type as FIGS. 3A to 3D.

FIGS. 5A, 5B, 5C and 5D relate to an oxygen carrier solid according to example 5 (example in accordance with the invention), and are of the same type as FIGS. 3A to 3D.

FIGS. 6A, 6B, 6C and 6D relate to an oxygen carrier solid according to example 6 (example in accordance with the invention), and are of the same type as FIGS. 3A to 3D.

FIG. 7 is a graph representing the amounts X of Fe and Y of Mg (as % by weight of Fe₂O₃ and as % by weight of MgO) of the oxygen carrier according to the invention, on which the examples have been plotted.

### DESCRIPTION OF THE EMBODIMENTS

The object of the invention is to provide an oxygen carrier solid for a chemical looping redox process, such as a CLC process, but also for other chemical looping redox processes such as a chemical looping reforming (CLR) process or a chemical looping oxygen uncoupling (CLOU) process.

The present invention also relates to the preparation and use of the oxygen carrier solid in such processes, in particular in a CLC process.

CLC processes generally involve two different reactors: a reduction reactor and an oxidation reactor. In the reduction reactor, the oxygen carrier solid is reduced by means of a fuel, or more generally a reducing gas, liquid or solid. The effluents from the reduction reactor mainly contain CO₂ and water, allowing easy capture of the CO₂. In the oxidation reactor, restoring the oxygen carrier solid to its oxidized state by contact with air or any other oxidizing gas makes it possible to generate in conjunction a hot energy-carrying effluent and an oxygen-poor or oxygen-depleted nitrogen stream (when air is used).

In the present description, reference is especially made to the use of the oxygen carrier solid in a circulating fluidized-bed CLC process, but the oxygen carrier solid according to the invention may also be used in any other type of chemical looping (CLC, CLR, CLOU) redox process in a fixed, moving or ebullated bed, or alternatively in a rotating reactor.

Embodiments of the oxygen carrier according to the invention, the process of manufacturing same and the use thereof will now be described in detail. In the following detailed description, many specific details are presented in order to provide a deeper understanding of the invention. However, it will be apparent to a person skilled in the art that the invention can be implemented without these specific details. In other cases, well-known characteristics have not been described in detail in order to avoid unnecessarily complicating the description.

A few definitions are given below for better understanding of the invention.

In the present description, the term “to comprise” is synonymous with (means the same thing as) “to include” and “to contain”, and is inclusive or open-ended and does not exclude other elements that are not mentioned. It is understood that the term “comprise” includes the exclusive and closed term “consist”.

In the present description, the expression “between . . . and . . . ” means that the limiting values of the interval are included in the described range of values, unless otherwise specified.

In the present invention, the different ranges of values of given parameters can be used alone or in combination. For example, a preferred range of pressure values can be combined with a more preferred range of temperature values, or a preferred range of values of a chemical compound or element can be combined with a more preferred range of values of another chemical compound or element.

### The Oxygen Carrier Solid

The oxygen carrier solid comprises, in the oxidized form thereof:
iron (Fe) in a content X of between 5% and 39.3% expressed by weight of Fe₂O₃ relative to the total weight of the oxygen carrier solid;
magnesium (Mg) in a content Y of between 3% and 2 [symbol] [symbol] 0.5% expressed by weight of MgO relative to the total weight of the oxygen carrier solid;
aluminium (Al) in a content Z of between 57% and 92% expressed by weight of Al₂O₃ relative to the total weight of the oxygen carrier solid;
with Y≤28.33-0.645X, the sum of the contents X, Y and Z being equal to [symbol] [symbol] 00%;
an active redox mass comprising Fe₂O₃;
a ceramic matrix within which said active redox mass is dispersed, said ceramic matrix comprising a substoichiometric spinel of formula MgₐAl_{b}O₄,
with:

$$a = \frac{4}{( 1 + ( 3 \times ( \frac{( 100 - X )}{Y} - 1 ) \times \frac{{M}_{MgO}}{{M}_{Al 2 O 3}} ) )} \qquad Math 3$$

$$b = \frac{8 \times ( 100 - X - Y )}{( Y \times \frac{{M}_{Al 2 O 3}}{{M}_{MgO}} + 3 \times ( 100 - X - Y ) )} \qquad Math 4$$

M_{MgO} and M_{Al2O3} are the molar masses of MgO and Al₂O₃, respectively.

The composition of the oxygen carrier solid according to the invention is understood to be an “initial” composition, as known to those skilled in the art, i.e. after obtaining the oxygen carrier solid according to the described manufacturing process and prior to using the oxygen carrier in a chemical looping redox process, such as CLC. The oxygen carrier is, in this initial state (i.e. post-production, during storage, and before use in the chemical looping redox process), in an oxidized form. Thus the composition of the oxygen carrier given above is a composition for the oxygen carrier in its initial oxidized form.

According to the invention, the amounts of Fe, Mg and Al in the oxygen carrier are such that the sum of the number of Fe ions and Mg ions is less than half the number of Al ions in the oxygen carrier in its oxidized form, so that all the iron present in the oxygen carrier can react with the sub-stoichiometric spinel of formula MgₐAl_{b}O₄ during the reduction to form a mixed spinel of (Fe,Mg)_{a′}Al_{b′}O₄ type, which limits the mobility of the iron toward the periphery of the particles (a′ and b′ depend on the amount of Fe incorporated into the spinel during reduction, and vary with X).

In the oxygen carrier according to the invention, iron constitutes the active redox mass, in the Fe₂O₃ hematite form thereof. The active redox mass thus comprises Fe₂O₃. The redox couple involved is essentially the Fe²⁺/Fe³⁺ couple, iron having an oxidation number of +III (Fe³⁺) in hematite Fe₂O₃. In hematite, iron can be partially replaced by aluminum (and form phases such as Al_{c}Fe_{2-c}O₃, Fe_{d}Al_{2-d}O₃). During the reduction of the oxygen carrier, iron in the Fe²⁺ form can be inserted into the sub-stoichiometric spinel MgₐAl_{b}O₄ of the ceramic matrix.

According to one or more embodiments, the Fe content X is between 20% and 39%, preferably between 25% and 35% expressed by weight of Fe₂O₃ relative to the total weight of the oxygen carrier solid (in the oxidized form thereof).

According to one or more embodiments, the Fe content X is between 5% and 25%, preferably between 5% and [symbol] [symbol] 9% expressed by weight of Fe₂O₃ relative to the total weight of the oxygen carrier solid (in the oxidized form thereof).

According to one or more embodiments, the ceramic matrix further comprises alpha-alumina (α-Al₂O₃).

During the preparation of the oxygen carrier as described below, in particular during the calcination carried out according to step (e [symbol] [symbol] )(iii) and/or step (e2)(jjj) and/or step (e3)(k) detailed below, a mixture of hematite Fe₂O₃ and a sub-stoichiometric spinel of formula MgₐAl_{b}O₄, or a mixture of corundum, also referred to as α-alumina or α-Al₂O₃, hematite Fe₂O₃ and a sub-stoichiometric spinel of formula MgₐAl_{b}O₄, is obtained, in particular depending on the calcination temperature applied. Depending on the calcination time and temperature applied, cationic doping of one of these three phases by the others can also occur, giving rise to the formation of mixed crystallographic phases of the FeₑMg·₋ₑAlO₄ and Al_{c}Fe_{2-c}O₃ type which are difficult to distinguish by XRD analysis (0<e, 0<c<2, d<0.2).

The hematite and corundum compounds are isostructural, but the lattice parameters are too different to form a solid solution between the two compounds. However, aluminum can replace a fraction of the iron in hematite, and conversely iron can replace a portion of the aluminum in corundum (Microstructural and Microchemical Characterization of Roman period Terra Sigillate slips from Archeological sites in Southern France, J. Am. Ceram. Soc., 89, 2006, [symbol] [symbol] 053).

According to one or more embodiments, the ceramic matrix consists essentially of hematite and a sub-stoichiometric spinel of formula MgₐAl_{b}O₄, or of hematite, alpha-alumina and a sub-stoichiometric spinel of formula MgₐAl_{b}O₄.

A ceramic matrix “essentially consisting of” is understood to mean that the matrix comprises more than 95% of the components mentioned (mixture of hematite and sub-stoichiometric spinel of formula MgₐAl_{b}O₄, or mixture of hematite, sub-stoichiometric spinel of formula MgₐAl_{b}O₄ and alpha-alumina).

A reminder is given hereinbelow of what is commonly understood by spinels, along with the definition of the sub-stoichiometric spinel included in the composition of the oxygen carrier solid according to the invention.

The spinel group consists of oxides, the structure of which reproduces that of the mineral spinel MgAl₂O₄. Among the oxides having a spinel structure are many natural compounds, such as magnetite (Fe₃O₄), chromite (FeCr₂O₄) and gahnite (ZnAl₂O₄). The general formula of spinels is AB₂O₄, where A is a divalent cation and B is a trivalent cation. In the spinel structure, the oxide ions (O²⁻) form a face-centered cubic lattice. This lattice has two kinds of interstitial sites: tetrahedral sites and octahedral sites. In particular, the primitive cubic unit cell of the spinel lattice has in particular 64 tetrahedral sites, of which only 8 are occupied by metal ions, and 32 octahedral sites, of which [symbol] [symbol] 6 are occupied. Two particular types of cation arrangements have been observed. In normal spinels, trivalent ions occupy the octahedral sites and divalent ions occupy the tetrahedral sites. Each oxide ion is thus connected to one divalent ion and three trivalent ions. In inverse spinels, the tetrahedral sites are occupied by half of the trivalent ions and the octahedral sites by the other half of the trivalent ions and by the divalent ions. There are also spinels where both types of cations occupy both the tetrahedral and octahedral sites: these are mixed spinels, of which the two previously mentioned cases are the limiting cases (SMIT and WIJN, Les Ferrites, Techn. Philipps, [symbol] [symbol] 96 [symbol] [symbol] ).

Gamma-alumina is commonly described as a spinel structure with vacancies, in which structure the oxide ions have approximately cubic close packing. Each alumina unit cell contains 2 [symbol] [symbol] ⅓ aluminum ions (Al³⁺) distributed among the octahedral and tetrahedral sites, whereas the 2⅔ vacancies are randomly distributed among the tetrahedral sites. Under oxidizing conditions and at high temperature, M²⁺ cations may insert into these vacancies, at the same time as oxide ions complete the cubic close packing characteristic of spinel in order to maintain the electrical neutrality of the crystal lattice. When a stoichiometric amount of metal M is present (i.e. one M²⁺ and one O²⁻ per Al₂O₃ unit cell), the spinel MAl₂O₄ is thus obtained (M=Mg, Ca, Zn, Fe, Cu, etc.). When the amount of inserted cations is less than the stoichiometry, a sub-stoichiometric spinel is obtained, i.e. not all the vacancies are occupied by an M²⁺ cation.

Thus, the formation of a spinel from MgO and Al₂O₃ in a mole ratio n proceeds according to the equation below (A. P. Tomsia and A. M. Glaeser, Ceramic Microstructures. Control at the Atomic Level, Springer US, Boston, MA, [symbol] [symbol] 998):

MgO+nAl₂O₃→(1+3n)/4Mg_{4/(1+3n)}Al_{Sn/1+3n)}O₄ Chem 4

If n is greater than [symbol] [symbol] , the spinel obtained is sub-stoichiometric in Mg.

In the formula MgₐAl_{b}O₄, of the sub-stoichiometric spinel of the matrix of the oxygen carrier according to the invention, the subscripts a and b are expressed according to the following relationships:

$$a = \frac{4}{( 1 + ( 3 \times ( \frac{( 100 - X )}{Y} - 1 ) \times \frac{{M}_{MgO}}{{M}_{Al 2 O 3}} ) )} \qquad Math 5$$

$$b = \frac{8 \times ( 100 - X - Y )}{( Y \times \frac{{M}_{Al 2 O 3}}{{M}_{MgO}} + 3 \times ( 100 - X - Y ) )} \qquad Math 6$$

M_{MgO} and M_{Al2O3} are the respective molar masses of MgO and Al₂O₃, X is the Fe content expressed as weight of Fe₂O₃ relative to the total weight of the oxygen carrier solid (in its oxidized form), and Y is the content of Mg expressed as weight of MgO relative to the total weight of the oxygen carrier solid (in its oxidized form).

In the context of the invention, the values of X and Y are limited to those within the gray triangle shown in figure [symbol] [symbol] , so as to ensure the sub-stoichiometry of the spinel. This is also reflected by the relationship Y≤28.33-0.645X, with X between 5% and 39.3% and Y between 3% and 2 [symbol] [symbol] 0.5%.

Without being committed to a particular theory, the inventors attribute the substantial improvement obtained in the presence of a sub-stoichiometric spinel of general formula MgₐAl_{b}O₄ to the formation of another spinel of formula (Mg,Fe)_{a′}Al_{b′}O₄ during the reduction of the Fe₂O₃ active mass (by the fuel in the case of CLC), which limits the reduction of the Fe³⁺ ferric ions to Fe²⁺ ferrous ions, as implied by the results reported by Gayan et al. (“Testing of a highly reactive impregnated Fe₂O₃/Al₂O₃ oxygen carrier for a SR-CLC system in a continuous CLC unit”, Fuel Processing Technol., 96, 20 [symbol] [symbol] 2, 37-47). This limits the reduction of the ferrous ions to metallic iron, and also the undesirable migration of iron to the outside of the particles, which can, with the accumulation of the redox cycles, lead to the formation of a surface layer of iron on the surface which causes the particles to agglomerate.

According to one or more embodiments, the oxygen carrier solid has a macroporous texture, this specific porosity being characterized as follows:
a total pore volume of the oxygen carrier solid Vtot, measured by mercury porosimetry, of between 0.05 and [symbol] [symbol] 0.2 ml/g;
a pore volume of the macropores constituting at least [symbol] [symbol] 0% of Vtot;
a size distribution of macropores within the oxygen carrier solid, measured by mercury porosimetry, of greater than 50 nm and less than or equal to 7 μm.

This macroporous texture is the initial texture of the oxygen carrier solid, i.e. before any use in a chemical looping redox process such as CLC.

Such an initial macroporous texture of the oxygen carrier solid further prevents the migration of the active mass, i.e. iron, within the particles.

It is recalled that according to the IUPAC nomenclature, micropores are defined as pores having a size (aperture) of less than 2 nm, mesopores are defined as pores having a size of between 2 nm and 50 nm, and macropores are defined as pores greater than 50 nm in size.

The term “total pore volume” means the volume measured with a mercury intrusion porosimeter according to the standard ASTM D4284-83 at a maximum pressure of 4000 bar (400 MPa), using a surface tension of 484 dynes/cm and a contact angle of [symbol] [symbol] 40°. The wetting angle used was taken as equal to [symbol] [symbol] 40° following the recommendations of the publication “Techniques de I'ingénieur, traité analyse et caractérisation” [Techniques of the Engineer, Analysis and Characterization Treatise], pages [symbol] [symbol] 050- [symbol] [symbol] 055, written by Jean Charpin and Bernard Rasneur.

The total pore volume of the solid is measured by mercury porosimetry, more specifically the measurement relates to the volume of mercury injected when the pressure exerted increases from 0.2 [symbol] [symbol] MPa to 4 [symbol] [symbol] 3 MPa. It is considered that below 0.2 [symbol] [symbol] MPa, the mercury fills the voids between the oxygen carrier particles (which corresponds to a pore diameter of 7 μm), and that above 0.2 [symbol] [symbol] MPa, the mercury penetrates into the pores of said particles.

The total pore volume Vtot of the oxygen carrier solid is more preferentially between 0. [symbol] [symbol] ml/g and 0.85 ml/g.

More preferentially, the pore volume of the macropores constitutes at least 40% of Vtot of the oxygen carrier solid, and even more preferentially at least 50% of Vtot. The remainder of the pore volume may be either microporosity or mesoporosity in any proportion.

The size distribution of the macropores within the particles, measured by mercury porosimetry, is more preferentially greater than 50 nm and less than or equal to 3 μm, and even more preferably greater than 50 nm and less than or equal to 500 nm.

The macropore volume is measured by mercury intrusion porosimetry according to the standard ASTM D4284-83 at a maximum pressure of 4000 bar (400 MPa), using a surface tension of 484 dynes/cm and a contact angle of [symbol] [symbol] 40°. The value at and above which the mercury fills all the intergranular voids is set at 0.2 [symbol] [symbol] MPa and it is considered that, above this value, the mercury penetrates into the pores of the sample.

The mesopore volume is measured in the same way as the macropore volume.

The macropore volume is defined as being the cumulative volume of mercury introduced at a pressure of between 0.2 [symbol] [symbol] MPa and 30 MPa, corresponding to the volume contained in the pores with an apparent diameter of greater than 50 nm and less than 7 μm.

The mesopore volume is defined as being the cumulative volume of mercury introduced at a pressure of between 29.6 MPa and 4 [symbol] [symbol] 3 MPa, corresponding to the volume contained in the pores with an apparent diameter of between 3.6 and 50 nm.

The micropore volume is measured by nitrogen porosimetry. The quantitative analysis of the microporosity is performed by means of the “t” method (Lippens-De Boer method, [symbol] [symbol] 965), which corresponds to a transform of the starting adsorption isotherm, as described in the publication “Adsorption by Powders and Porous Solids. Principles, Methodology and Applications”, written by F. Rouquérol, J. Rouquérol and K. Sing, Academic Press, [symbol] [symbol] 999.

According to the invention, the oxygen carrier solid may be prepared from the treatment of solid particles obtained by a technique of spray-drying of an aqueous suspension of aluminum oxide(s), hydroxides and/or oxyhydroxides of specific size. The micronized powder obtained after drying may then be calcined, for example at 700° C., to convert the aluminum hydroxides and/or oxyhydroxides into gamma-alumina. A sub-stoichiometric spinel of formula MgₐAl_{b}O₄ may then be formed by dry impregnation of soluble Mg precursors, typically with magnesium nitrate. After drying and calcining the particles, the oxygen carrier solid according to the invention may then be dry-impregnated with a soluble iron precursor, typically iron nitrate. The impregnation with soluble iron and Mg precursors may also be performed simultaneously. Alternatively, the iron and magnesium precursors may be added to the aqueous suspension of aluminum oxide(s), hydroxides and/or oxyhydroxides prior to spray drying. The preparation of the oxygen carrier solid according to the invention is described in detail later in the description.

The oxygen carrier solid according to the invention is in the form of particles, which may be fluidized in the chemical looping redox process, notably performed in a circulating fluidized bed. They may be fluidizable particles (fluidizable powder, generally referred to as “fluidizable carrier”) belonging to groups A, B or C of the Geldart classification (D. Geldart, “Types of gas fluidization”, Powder Technol., 7(5), [symbol] [symbol] 973, pages 285-292), and preferably the particles belong to group A or group B of the Geldart classification, and preferably to group B of the Geldart classification.

Preferably, the particles of the oxygen carrier solid have a particle size such that more than 90% of the particles have a size of between 50 μm and 600 μm, more preferentially a particle size such that more than 90% of the particles have a size of between 80 μm and 400 μm, even more preferentially a particle size such that more than 90% of the particles have a size of between [symbol] [symbol] 00 μm and 300 μm, and even more preferentially a particle size such that more than 95% of the particles have a size of between [symbol] [symbol] 00 μm and 300 μm.

Preferably, the particles of the oxygen carrier solid have a grain density of between 500 kg/m³ and 5000 kg/m³, preferably a grain density of between 800 kg/m³ and 4000 kg/m³, and even more preferentially a grain density of between [symbol] [symbol] 000 kg/m³ and 3000 kg/m³.

The particles of the oxygen carrier solid are preferably substantially spherical.

The size distribution and morphology of the particles for use in another type of chemical looping process (CLC, CLR, CLOU) in a fixed bed, in a moving bed or in a rotating reactor are suitable for the process envisaged. For example, in the case of a use of the oxygen carrier solid in a process using a fixed bed or rotating reactor technology, the preferred size of the particles is greater than 400 μm, in order to minimize the pressure drops in the reactor(s), and the morphology of the particles is not necessarily spherical. The morphology is dependent on the forming mode, for example in the form of extrudates, beads, monoliths or particles of any geometry obtained by grinding larger particles. In the case of a forming of monolithic type, the oxygen carrier solid, in the form of particles, is deposited on the surface of the ceramic monolith channels by means of coating methods known to those skilled in the art or else the monolith itself consists of the particles according to the invention.

The size of the particles may be measured by laser particle size analysis.

The particle size distribution of the oxygen carrier solid is preferably measured with a laser particle size analyzer, for example a Malvern Mastersizer 3000®, preferably in liquid mode, and using Fraunhofer theory. Such a technique and such equipment may also be used to measure the size of other grains such as the grains of precursor oxides of the ceramic matrix.

Producing oxygen carrier particles in the desired size range requires a forming step (see steps (B) and (F) described below) starting with smaller grains, the size of which is between 0. [symbol] [symbol] μm and 20 μm, preferentially between 0.5 μm and 5 μm, and more preferably between [symbol] [symbol] μm and 3 μm. The forming may be performed according to any technique known to those skilled in the art which makes it possible to obtain particles, such as extrusion, compacting, wet or dry granulation, for example agglomeration on a granulating plate or a granulating drum, freeze granulation, or by drop (oil drop) coagulation techniques, and preferably by means of a technique of spray drying or agglomeration on a granulating plate or granulating drum, making it possible to obtain particles of spherical shape.

A step of sieving and/or screening (classification or separation using a cyclone, for example) may also be performed so as to select the particles of the desired particle size.

### Preparation of the Oxygen Carrier Solid

The process for preparing the oxygen carrier includes several possible embodiments, which differ notably in the order of introduction of the iron and magnesium elements, as detailed in step (E).

The oxygen carrier solid may be prepared according to a process comprising the following steps:

### Step (A): Preparation of a Suspension of Precursor Oxide(s) of a Ceramic Matrix

Step (A) involves the preparation of an aqueous suspension of alumina particles and an aluminic binder, said suspension having rheological features suitable for pumping and spraying. The alumina particles form grains with a size between 0. [symbol] [symbol] μm and 20 μm, preferably between 0.5 μm and 5 μm, and more preferably between [symbol] [symbol] μm and 3 μm.

The alumina used may be chosen from transition aluminas, preferably from gamma, delta, theta and eta alumina, and more preferentially the alumina used is gamma-alumina.

The aluminic binder may be chosen from boehmite and/or aluminum hydroxides (bayerite, gibbsite or nordstrandite). It may be added in a proportion of from 5% to 30% by weight relative to the mass of aluminum oxide in suspension. The aluminic binder may be peptized with % to 0% by weight of an acid chosen from HCl, H₂SO₄ and HNO₃, preferentially HNO₃.

One or more organic and/or inorganic binders may be added to the suspension in order to adjust and control the rheology of the suspension and to ensure the cohesion of the particles that are obtained on conclusion of the forming step, before the consolidation by calcination in a subsequent step.

The organic binder(s) of varying molar mass may be selected from polyethylene glycol (PEG), polyvinyl alcohol (PVA), polyacrylate (PA), polyvinylpyrrolidone (PVP), etc. They may be added in a proportion of from 0.5% to 6% by weight relative to the mass of oxide(s) in suspension.

One or more pore-forming agents intended to increase the macroporosity of the particles may also be added to the suspension. Preferably, when such agents are added to the solution, the amount thereof is preferably less than 25% by weight relative to the mass of oxide(s) in suspension. Such agents are typically organic compounds that can be burnt, such as starch, cellulose, polymers such as polypropylene, latex or poly(methyl methacrylate) (PMMA).

### Step (B): Spray Drying

During this step, the suspension obtained in step (A) is spray dried: the suspension is sprayed as fine droplets into a drying chamber by spraying means, for example using a pneumatic (dual-fluid) or hydraulic (single-fluid) spraying nozzle, and these droplets are simultaneously placed in contact with a hot carrier gas, preferably air or nitrogen, raised to a temperature of between [symbol] [symbol] 80° C. and 350° C. The hot carrier gas may be introduced with a co-current stream (ceiling mode) or a mixed stream (fountain mode) allowing evaporation of the solvent and the production of spherical particles having the desired particle size.

This step advantageously enables the formation of particles having the desired particle size. Preferably, this step is performed so as to produce particles of the following particle size: more than 90% of the particles have a size between 50 and 600 μm, preferably more than 90% of the particles have a size between 80 μm and 400 μm, even more preferentially more than 90% of the particles have a size between [symbol] [symbol] 00 μm and 300 μm, and even more preferentially more than 95% of the particles have a size between [symbol] [symbol] 00 μm and 300 μm.

A subsequent optional screening step (D) may be performed so as to obtain the desired particle size, described below.

### Step (C): Calcining of the Spray-Dried Particles

The particles resulting from the spray-drying in step (B) are calcined in air at a temperature of between 400° C. and [symbol] [symbol] 400° C., preferentially between 600° C. and [symbol] [symbol] 200° C., and very preferably between 650° C. and 950° C. This calcination step has an impact on the mechanical strength of the particles.

This calcination may be performed for a period of [symbol] [symbol] to 24 hours, and preferably for a period of 3 to 6 hours.

It is possible to perform a temperature increase ramp of between [symbol] [symbol] ° C./min and 50° C./min, and preferably between 5° C./min and 20° C./min, to reach the given calcination temperature, notably when the integration of iron and magnesium precursors into the oxygen carrier solid is performed according to step (E) (e3) described below. The time for implementing this temperature ramp is not included in the calcination time ranges indicated above.

If the incorporation of the Mg precursor, and possibly the Fe precursor, is performed before step (C), as described in step (E) (e3), the calcination in this step (C) is then preferably at a temperature of between 700° C. and [symbol] [symbol] 400° C., preferably performed in air and more preferentially between 700° C. and [symbol] [symbol] 000° C., even more preferentially between 750° C. and 950° C., even more preferably between 800° C. and 950° C. or even between 900° C. and 950° C., in particular when the Fe precursor has been incorporated beforehand. In the case of such an incorporation of precursor(s) before step (C) as described in step (E) (e3), the calcination is then preferably performed for a period of 5 hours to [symbol] [symbol] 5 hours. This calcination then enables the formation of the sub-stoichiometric spinel of formula MgₐAl_{b}O₄, hematite, and optionally corundum, and optionally partially substituted compounds of the FeₑMg·₋ₑAlO₄, Al_{c}Fe_{2-c}O₃ and Fe_{d}Al_{2-d}O₃ type.

### Step (D): Optional Screening of the Particles

Screening may be performed on conclusion of the calcination step (C), directed toward selecting the particles in a desired size range. In particular, the screening may be performed so as to obtain particles with a size of between 50 μm and 600 μm, more preferentially between 80 μm and 400 μm, and even more preferentially between [symbol] [symbol] 00 μm and 300 μm.

The screening may be performed by separating the particles using a cyclone, or any other separation means.

### Step (E): Integration of Fe and Mg

Step (E) includes either step (e [symbol] [symbol] ) followed by step (e2), or step (e3) where Fe and Mg are integrated before step (B), or step (e3) where only Mg is integrated before step (B) in combination with step (e2).

Step (e [symbol] [symbol] ) allows Mg to be combined with alumina to produce the sub-stoichiometric spinel MgₐAl_{b}O₄.

Step (e2) allows the Fe oxide to be combined with the sub-stoichiometric spinel obtained in step (e [symbol] [symbol] ) or alternatively obtained on conclusion of step (C) if step (e3) is performed.

Step (e3) allows the Mg, and possibly the Fe, to be combined as early as step (A) for preparing the aluminum oxide suspension. Step (e3) is combined with step (e2) if the Fe is not incorporated during step (e3).

According to the invention, the amounts of magnesium and iron precursors are calculated so that the total number of moles of Fe and Mg does not exceed the number of vacant cation sites in the spinel structure of the gamma-alumina, i.e. (n_{Fe}+n_{Mg})<(n_{Al}/2), where n_{Fe}, n_{Mg} and n_{Al} are the number of moles of iron, magnesium and aluminum in the oxygen carrier.

The amounts of magnesium and iron precursors are preferably calculated so that Y is between 3% and 2 [symbol] [symbol] 0.5% and X is between 5% and 39.3%, with Y≤28.33-0.645X, so as to form the sub-stoichiometric spinel of formula MgₐAl_{b}O₄.

### Step (e1): Impregnation, Drying and Calcination of Alumina Particles in Order to Insert Mg

According to this step (e [symbol] [symbol] ), the calcined particles obtained on conclusion of step (C), and optionally screened on conclusion of step (D), are (i) impregnated with an aqueous or organic solution containing at least one soluble Mg precursor compound.

Preferably the dry impregnation is performed with an aqueous solution containing hydrated magnesium nitrate. The concentration of soluble Mg precursor(s), e.g. hydrated Mg nitrate, in the impregnation solution is calculated so that Y is between 3% and 25%, with Y≤28.33-0.645*X, and with X between 5% and 39.3%.

The impregnated particles are then (ii) dried, for example in an oven, and preferably in air or under a controlled atmosphere. The term “controlled atmosphere” means, for example, with controlled relative humidity or under nitrogen. This drying is performed at a temperature of between 30° C. and 200° C.

More preferentially, this drying is performed in air at a temperature of between [symbol] [symbol] 00° C. and [symbol] [symbol] 50° C.

The impregnation may be performed in one or more successive steps.

If the impregnation is performed in several successive steps, an intermediate calcination step at a temperature of between 400° C. and 600° C. is preferably performed.

Finally, the impregnated and dried particles are then (iii) calcined. This second (or n^{th} if the impregnation is performed several times) calcination step (the first being that of step (C)) results in the sub-stoichiometric spinel.

This calcination (iii) is performed between 700° C. and [symbol] [symbol] 400° C., preferably in air, more preferentially between 700° C. and [symbol] [symbol] 000° C., and even more preferentially between 750° C. and 950° C.

This calcination may be performed for a period of [symbol] [symbol] to 24 hours, and preferably for a period of 3 to 6 hours.

Advantageously, a temperature increase ramp of between [symbol] [symbol] ° C./min and 50° C./min, and preferably between 5° C./min and 20° C./min, is applied to achieve the given calcination temperature. The time for implementing this temperature ramp is not included in the calcination time ranges indicated above.

This calcination may allow the formation of the first sub-stoichiometric spinel.

### Step (e2): Impregnation of the Sub-Stoichiometric Spinel in Order to Integrate Fe

According to this step (e2), the calcined particles obtained on conclusion of step (e [symbol] [symbol] ) are (j) impregnated with an aqueous or organic solution containing at least one soluble iron precursor compound.

Alternatively, said impregnation (j) may be performed on the calcined particles obtained from step (C) or optionally screened particles obtained from step (D) in the case where step (e3) described below is performed, without Fe being incorporated during one of the sub-steps (k), (kk) and (kkk) of step (e3).

Preferably said impregnation is performed with an aqueous solution containing hydrated iron nitrate Fe(NO₃)₃₋ₓH₂O. The concentration of soluble Fe precursor(s), for example hydrated Fe nitrate, in the aqueous solution is calculated so as to comply with the relationship Y≤28.33-0.645*X, with X between 5% and 39.3% and Y between 3% and 25%.

The impregnated particles are then (jj) dried, for example in an oven, and preferably in air or under a controlled atmosphere (controlled relative humidity, under nitrogen). This drying is performed at a temperature of between 30° C. and 200° C.

More preferentially, this drying is performed in air at a temperature of between [symbol] [symbol] 00° C. and [symbol] [symbol] 50° C.

Finally, the impregnated and dried particles are then (jjj) calcined. This third (or n^{th} if the impregnation is performed several times, or second if step (e3)(kkk) is performed) calcination step (the first being that of step (C)) results in the oxygen carrier solid.

This calcination allows the formation of the first and/or the second sub-stoichiometric spinel.

The impregnation may be performed in one or more successive steps.

If the impregnation is performed in several successive steps, an intermediate calcination step at a temperature of between 400° C. and 600° C. is preferably performed.

This calcination (jjj) is performed between 700° C. and [symbol] [symbol] 400° C., preferably in air, more preferentially between 700° C. and [symbol] [symbol] 000° C., and even more preferentially between 800° C. and 950° C., or even between 900° C. and 950° C.

This calcination may be performed for a period of [symbol] [symbol] to 24 hours, and preferably for a period of 5 to [symbol] [symbol] 5 hours.

Advantageously, a temperature increase ramp of between [symbol] [symbol] ° C./min and 50° C./min, and preferably between 5° C./min and 20° C./min, is applied to achieve the given calcination temperature. The time for implementing this temperature ramp is not included in the calcination time ranges indicated above.

### Step (e3): Addition of the Precursors of Mg, and Optionally of Fe, Before Step (B)

According to step (e3), and as an alternative to that which is performed during the sequence of steps (e [symbol] [symbol] ) and (e2), the precursors of Mg and optionally of Fe are combined with the alumina matrix prior to the spray-drying step (B), before or after the preparation of the suspension in step (A), so as to form a suspension comprising the precursors of Mg, and optionally of Fe.

The incorporation of the precursors may then be performed according to one of the following three sub-steps (k), (kk) or (kkk), and preferably according to sub-step (kkk):

(k) impregnating the alumina particles used for preparing the suspension in step (A) with at least one Mg precursor compound, and optionally with an Fe precursor compound. Said iron and magnesium precursor compounds are preferentially hydrated iron and magnesium nitrates. This sub-step (k) is performed before step (A): the impregnation is performed prior to placing the alumina particles in suspension. A drying step followed by a calcination step, as described in step (e [symbol] [symbol] ) (ii) and (iii), may be performed following this impregnation (k).

(kk) addition of at least one soluble Mg precursor, and optionally a soluble Fe precursor, to the suspension prepared in step (A). Advantageously, the soluble compound is a hydrated nitrate for the soluble Fe precursor and a hydrated iron nitrate for the soluble Mg precursor. This sub-step (kk) is thus performed after step (A) and before step (B).

(kkk) addition to the suspension prepared in step (A) of at least one oxide or hydroxide of Mg, and optionally an oxide or hydroxide of Fe. These compounds added to the suspension prepared in step (A) are solids in the form of grains, with a size of between 0. [symbol] [symbol] μm and 20 μm, preferably between 0. [symbol] [symbol] μm and 5 μm, and more preferably between 0. [symbol] [symbol] μm and [symbol] [symbol] μm. This sub-step (kkk) is thus performed after step (A) and before step (B).

It is understood that step (e2) is necessarily performed in combination with step (e3) if no soluble Fe precursor compound or Fe oxide or hydroxide is added during sub-steps (k), (kk) and (kkk) in step (e3). This then allows the Fe to be incorporated by impregnation of the sub-stoichiometric spinel obtained on conclusion of step (C) when step (e3) is performed.

In step (e3), the concentration of Mg and/or Fe precursors is calculated as defined previously for steps (e [symbol] [symbol] ) and (e2).

Advantageously, performing step (e3) with the integration of both Fe and Mg makes it possible to simplify the process for preparing the oxygen carrier by dispensing with the impregnation steps (e [symbol] [symbol] ) and (e2).

The preparation of the oxygen carrier solid according to the invention may comprise the recycling, into step (E)(kkk), of fines of the oxygen carrier produced during its use in a chemical looping redox process such as CLC, for example by adding during step (kkk) to the suspension prepared in step (A) less than [symbol] [symbol] 0% by weight of fines relative to the total oxide content of the suspension. The recycled fines are generally less than 40 μm in size. A step of grinding the fines may thus be necessary to achieve a particle size distribution of the fines of between 0. [symbol] [symbol] μm and 20 μm, preferably between 0.5 μm and 5 μm, and more preferably between [symbol] [symbol] μm and 3 μm.

Step (F): Forming the Particles Obtained from Step (E)—Optional

If the forming of the grains to the desired shape and particle size has not been performed on conclusion of step (B), the particles obtained from step (E) may be formed during this step (F) so as to obtain particles of the oxygen carrier having the desired form and particle size, as described previously.

In particular, the forming in this step may be performed to produce particles having a particle size such that more than 90% of the particles have a size between 50 μm and 600 μm, more preferably between 80 μm and 400 μm, and even more preferentially between [symbol] [symbol] 00 μm and 300 μm, and even more preferentially a particle size such that more than 95% of the particles have a size between [symbol] [symbol] 00 μm and 300 μm.

If a circulating fluidized bed implementation is envisaged in the chemical looping redox process using the oxygen carrier solid, the forming is preferably performed in such a way as to obtain a particle size distribution such that said particles belong to class A or class B of the Geldart classification, and more preferentially to class B.

The forming may be performed according to any technique known to those skilled in the art for obtaining particles, such as spray drying, wet or dry granulation, for example agglomeration on a granulating plate or granulating drum, freeze granulation, or by drop (oil drop) coagulation techniques, and preferably by means of a technique of spray drying or agglomeration on a granulating plate or granulating drum, which make it possible to obtain spherical particles, in particular having the specific particle size mentioned above, and more preferentially according to a spray drying technique.

The forming may also be performed according to other techniques such as extrusion or compaction, known to those skilled in the art, making it possible, for example, to obtain particles often of larger size, for example non-spherical particles, which can be used in a fixed bed or moving bed.

The forming may optionally comprise a screening and/or cycloning step, in order to obtain agglomerates of the desired particle size.

### Use of the Oxygen Carrier Solid

The oxygen carrier solid is intended to be used in a chemical looping redox process.

The invention thus relates to a chemical looping redox process using the oxygen carrier solid as described, or prepared according to the preparation process as described.

Advantageously, the oxygen carrier solid described is used in a CLC process of a hydrocarbon feedstock, in which the oxygen carrier solid is in the form of particles and circulates between at least one reduction zone and one oxidation zone both operating in a fluidized bed.

The temperature in the reduction zone and in the oxidation zone is between 600° C. and [symbol] [symbol] 200° C., preferably between 750° C. and [symbol] [symbol] 00° C., and even more preferentially between 800° C. and [symbol] [symbol] 00° C.

The treated hydrocarbon feedstock may be a solid, liquid or gaseous hydrocarbon feedstock: gaseous fuels (for example: natural gas, syngas, biogas), liquid fuels (for example: fuel oil, bitumen, diesel, gasolines, etc.), or solid fuels (for example: coal, coke, petcoke, biomass, oil sands, etc.).

The operating principle of the CLC process in which the oxygen carrier solid described is used is as follows: a reduced oxygen carrier solid is placed in contact with a stream of air, or any other oxidizing gas, in a reaction zone referred to as an air reactor (or oxidation reactor). This results in a depleted air stream and a stream of reoxidized particles of the oxygen carrier solid. The stream of oxidized oxygen carrier particles is transferred into a reduction zone referred to as a fuel reactor (or reduction reactor). The particle stream is placed in contact with a fuel, typically a hydrocarbon feedstock. This results in a combustion effluent and a stream of reduced oxygen carrier particles. The CLC facility may include various items of equipment, for heat exchange, pressurization, separation or possible recirculations of material around the air and fuel reactors.

In the reduction zone, the hydrocarbon feedstock is placed in contact, preferably co-currentwise, with the oxygen carrier solid in the form of particles to perform the combustion of said feedstock by reduction of the oxygen carrier. The oxygen carrier is reduced by means of the hydrocarbon feedstock, which is correspondingly oxidized to CO₂ and H₂O, or possibly to a CO+H₂ mixture depending on the proportions of oxygen carrier and hydrocarbon feedstock used. The combustion of the feedstock in contact with the active mass is performed at a temperature generally between 600° C. and [symbol] [symbol] 200° C., preferentially between 600° C. and [symbol] [symbol] 00° C., and more preferentially between 800° C. and [symbol] [symbol] 00° C. The contact time varies depending on the type of combustible feedstock used. It typically ranges between [symbol] [symbol] second and [symbol] [symbol] 0 minutes, for example preferably between [symbol] [symbol] and 5 minutes for a solid or liquid feedstock, and for example preferably from [symbol] [symbol] to 20 seconds for a gaseous feedstock.

A mixture comprising the gases from the combustion and the particles of the oxygen carrier solid is discharged, typically at the top of the reduction zone. Gas/solid separation means, such as a cyclone, make it possible to separate the combustion gases from the solid particles of the oxygen carrier in their most reduced state. The latter are sent to the oxidation zone to be re-oxidized, at a temperature generally between 600° C. and [symbol] [symbol] 200° C., preferentially between 600° C. and [symbol] [symbol] 00° C., and more preferentially between 800° C. and [symbol] [symbol] 00° C.

In the oxidation reactor, the oxygen carrier is restored to its oxidized state on contact with air, before returning to the reduction zone, and after having been separated from the oxygen-depleted air discharged at the top of the oxidation zone.

The oxygen carrier solid, passing alternately from its oxidized form to its reduced form and vice versa, describes a redox cycle.

The oxygen carrier solid described may also be used in another chemical looping redox process such as a CLR process or a CLOU process.

The technology used in the chemical looping redox process is preferably that of the circulating fluidized bed, but is not limited to this technology, and may be extended to other technologies such as the fixed bed, moving bed or ebullated bed technology, or alternatively the rotating reactor technology.

### EXAMPLES

The advantage of the oxygen carrier solids according to the invention in the chemical looping processes, in particular CLC, in particular the minimization of the migration of the active mass within the particles during the redox cycles, is disclosed through the examples [symbol] [symbol] to 6 below.

Example 2 relates to an oxygen carrier solid not in accordance with the invention. Examples 3 to 6 relate to oxygen carrier solids in accordance with the invention.

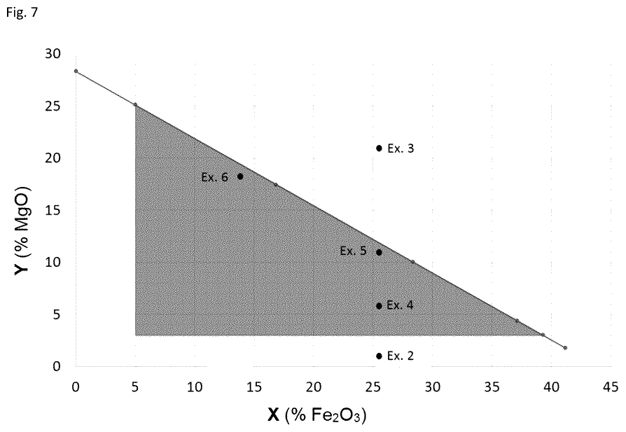

FIG. 7 shows where the examples lie in terms of the Fe content and Mg content thereof (as % of Fe₂O₃ and as % of MgO) in the graph from figure [symbol] [symbol] .

When reference is made in the examples below to figures representing X-ray diffractograms, the x-axis A corresponds to the angle 2θ (in degrees) and the y-axis Cps represents the number of counts during the measurement.

The diffraction diagrams (diffractograms) are obtained by radiocrystallographic analysis by means of a diffractometer using the conventional powder method with the Kα [symbol] [symbol] radiation of copper (λ= [symbol] [symbol] 0.5406 Å). On the basis of the position of the diffraction peaks represented by the angle 2θ, the interplanar spacings dₕₖₗ characteristic of the sample are calculated using Bragg's law. The measurement error Δ(dₕₖₗ) with regard to dₕₖₗ is calculated by virtue of Bragg's law as a function of the absolute error Δ(2θ) assigned to the measurement of 2θ. An absolute error Δ(2θ) equal to ±0.02 [symbol] [symbol] is commonly accepted.

The spinel formulae given in the examples below are theoretical formulae calculated from the contents of MgO and Al₂O₃.

The particle size distribution may be expressed below with the values for D_{V10}, Dᵥ₅₀ and D_{V90}. The diameter D_{V10} is defined as being the diameter such that, among all the particles, all the particles smaller than this diameter constitute 10% of the volume of the particles. The diameter D_{V90} is defined as being the diameter such that, among all the particles, all the particles smaller than this diameter constitute 90% of the volume of the particles. The diameter Dᵥ₅₀ is defined as being the median diameter such that, among all the particles, all the particles smaller than this diameter constitute 50% of the volume of the particles.

The particle size is determined by laser particle size analysis (Malvern Mastersizer 3000®, preferably in liquid mode, and using the Fraunhofer theory).

The term “specific surface area of a particle” (alumina or oxygen carrier) means the BET specific surface area determined by nitrogen adsorption in accordance with the standard ASTM D 3663-78 established from the Brunauer-Emmett-Teller method described in the journal The Journal of the American Chemical Society, 60, 309 (1938).

In the present patent application, the term “to comprise” is synonymous with (means the same thing as) “to include” and “to contain”, and is inclusive or open and does not exclude other elements which are not stated. It is understood that the term “comprise” includes the exclusive and closed term “consist”.

### Example 1: Aging Test for Oxygen Carrier Solids in a Batch Fluidized Bed

Aging of oxygen carrier solids in a fluidized bed as described below was performed in a unit (as described in H. Stainton et al., Fuel (2012) 101, 205-214) consisting of a quartz reactor, an automated system for feeding gas to the reactor and a system for analyzing the gases leaving the reactor. This is a fluidized bed process, referred to as a “batch” process.

This aging test approximates the conditions of use of the oxygen carrier solid in a chemical looping redox process, in particular a chemical looping combustion redox process.

The gases (CH₄, CO₂, N₂, air) are distributed by mass flow meters. For safety reasons, flushing with nitrogen is performed after each reduction and oxidation period.

The height of the quartz reactor is 30 cm, with a diameter of 4 cm in its lower part (over a height of 24 cm), and of 7 cm in its upper part. A quartz frit is placed at the bottom of the reactor to ensure the distribution of the gases and good fluidization of the particles. Another frit is placed in the upper part of the reactor to prevent the loss of fines during the test. The reactor is heated using an electric furnace. Some of the gas leaving the reactor is pumped to the gas analyzers, cooled to condense the majority of the water formed during the reduction and then dried with calcium chloride. The gas concentrations are measured using nondispersive infrared analyzers for CO, CO₂ and CH₄, a paramagnetic analyzer for oxygen, and a TCD detector for hydrogen.

Standard test conditions: 100 grams of particles are introduced into the quartz reactor and then heated to 900° C. in a stream of air (60 NI/h). When the temperature of the bed is stabilized at 900° C. in air, 250 cycles are performed according to the following steps:
1—Nitrogen flushing (60 NI/h)
2—Injection of a CH₄/CO₂ mixture (30 NI/h/30 NI/h) (particle reduction)
3—Nitrogen flushing (60 NI/h)
4—Injection of air (60 NI/h) (particle oxidation).

The conversion of the oxygen carrier solid (amount of oxygen supplied by the oxygen carrier solid to achieve methane conversion, expressed as % by weight of the oxidized oxygen carrier) is calculated from the gas conversion data, and the reduction time (step 2 of the cycle) is adjusted after the first cycle so that the oxygen carrier solid releases about 2% by weight of oxygen (relative to the oxidized mass of oxygen carrier solid introduced) in each reduction cycle. The oxidation time (step 4 of the cycle) is sufficient to completely reoxidize the particles (15 min).

The particle size distribution was measured with a Malvern particle size analyzer, using Fraunhofer theory.

The mercury porosimetry measurements were performed on an Autopore IV machine sold by Micromeritics, taking into account a mercury surface tension of 485 dynes/cm and a contact angle of 140°. The minimum pore size that can be measured by mercury porosimetry is 3.65 nm.

The nitrogen adsorption isotherms were performed on the ASAP 2420 machine sold by Micromeritics.

### Example 2: Carrier Solid Containing Fe₂O₃ (25% by Weight)/Al₂O₃ (75% by Weight) (not in Accordance)

According to this example 2, an oxygen carrier solid is formed by adding 25% by weight of iron oxide Fe₂O₃ by dry impregnation of iron nitrate on an alumina Al₂O₃.

The alumina used for this example is a powder obtained from an aqueous suspension of alumina by means of the spray-drying process, as described above in the detailed description of the preparation of the oxygen carrier solid. It was prepared as follows:

An aqueous suspension composed of 69.8% by weight of deionized water, 26.1% by weight of gamma-alumina grains, 3.9% by weight of boehmite grains and 0.2% by weight of nitric acid (68 wt % concentrated HNO₃) is prepared (step A) and then pumped to a spray dryer, where it is sprayed as fine droplets which, during the phase of drying and of evaporation of the water, will form spherical solid particles with a size larger than 100 μm (step B).

The particle size distribution of the gamma-alumina used in the preparation of the aqueous suspension indicates Dᵥ₁₀=1.56 μm, Dᵥ₅₀=3.73 μm and Dᵥ₉₀=7.47 μm. The specific surface area measured by nitrogen physisorption according to the B.E.T. method is 291 m²/g.

The particle size distribution of the boehmite used indicates Dᵥ₁₀=13.6 μm, Dᵥ₅₀=74.5 μm and Dᵥ₉₀=166 μm.

The dry particles obtained form a powder, which is then calcined (step (C)) for 4 hours in a muffle furnace at a temperature of 700° C. for 4 hours, and then screened (step (D)) between 125 μm and 315 μm to remove the finest particles.

The size distribution of the particles (alumina support) on conclusion of the screening step is characterized by the following parameters: Dᵥ₁₀=91 μm, Dᵥ₅₀=118 μm and Dᵥ₉₀=213 μm. The pore volume measured by mercury porosimetry of said particles (alumina support) is 0.893 ml/g, and a bimodal pore size distribution is observed. The pore size distribution for mesoporosity is between 4 and 50 nm (centered on 8.85 nm) and for macroporosity is greater than 50 nm and less than or equal to 1200 nm (centered on 640 nm). The macropore volume is 0.562 ml/g, i.e. 62.9% of the total pore volume measured by mercury porosimetry.

200 g of alumina particles thus obtained are dry-impregnated a first time with 190 ml of a 700 g/I solution of magnesium nitrate (Mg(NO₃)₂) and then dried at 120° C. for 12 hours and then calcined at 600° C. for 4 hours. A second dry impregnation of these particles with the same solution is then performed, followed by drying at 120° C. and calcination at 800° C. for 4 h. The MgO content of the support particles is then 28.3%, and the XRD analysis shows that the support consists of MgAl₂O₄.

Two successive dry impregnations of the spinel with an iron nitrate solution are then carried out, with intermediate calcination at 600° C., then final calcination at 900° C. for 12 h, making it possible to obtain particles containing about 25% by weight of Fe₂O₃ and 75% of Al₂O₃.

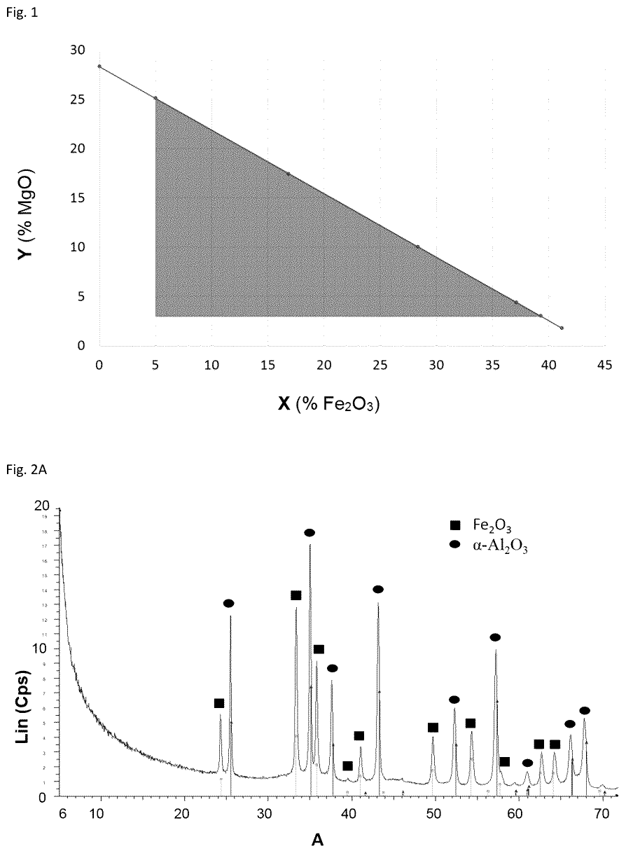

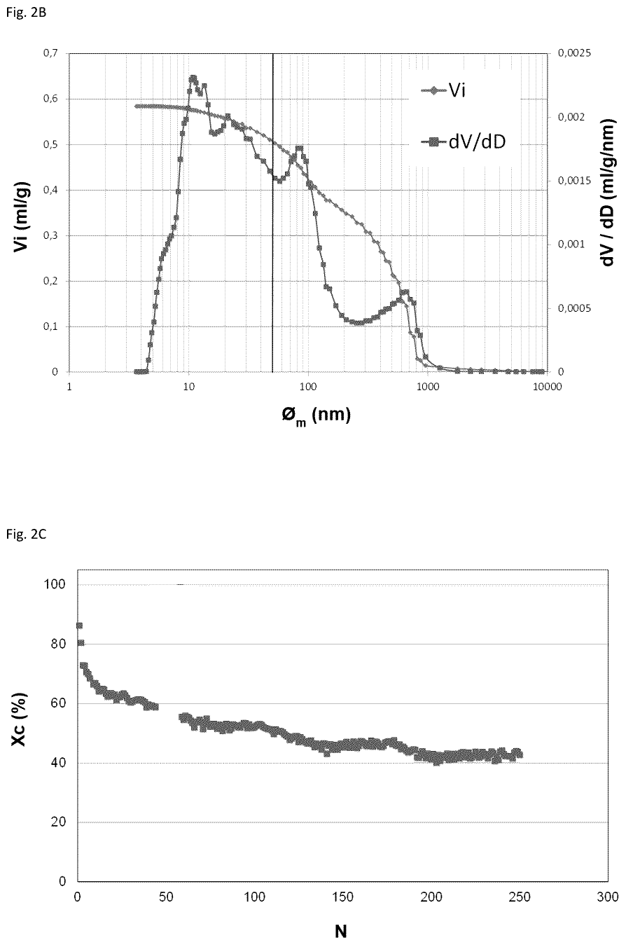

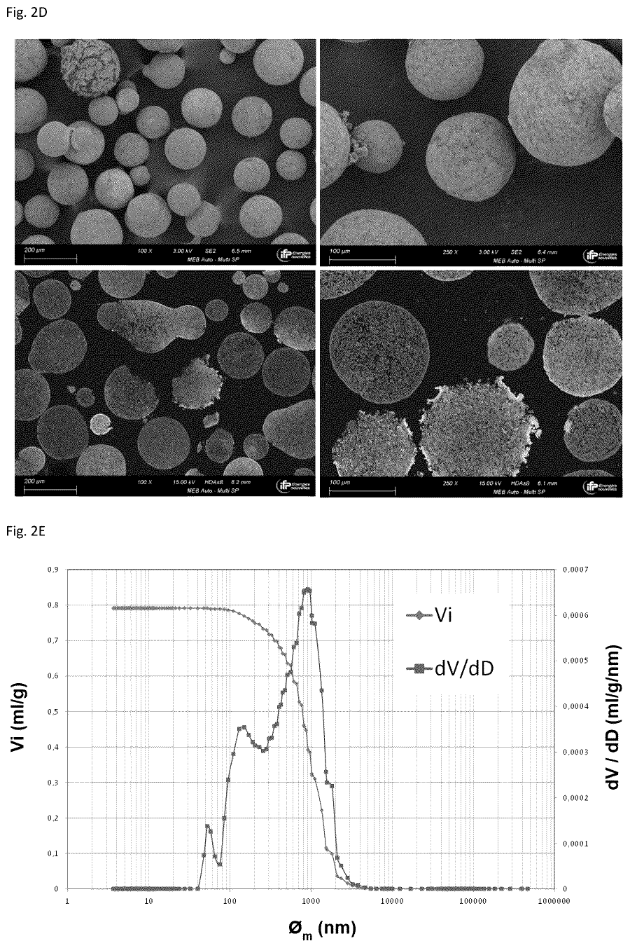

XRD analysis (FIG. 2A) shows that the particles do indeed consist of hematite Fe₂O₃ and alpha-alumina (α-Al₂O₃).

Impregnation of iron followed by calcination at 900° C. resulted in a strong modification of the porosity of the support. The pore volume, measured by mercury porosimetry, of the oxygen carrier is 0.584 ml/g. The mesopore volume of the oxygen carrier, measured between 3.65 nm and 50 nm, is 0.081 ml/g, and the macropore volume is 0.503 ml/g. FIG. 2B shows the volume of mercury injected Vi (ml/g) into the porosity as a function of the pore diameter (median diameter in nm), along with the ratio dV/dD (derivative of the (volume of Hg introduced/pore size)), giving information regarding the pore size distribution for the oxygen carrier solid in this example. The size distribution of the mesopores is between 4 nm and 50 nm and centered on 11.15 nm. The size distribution of the macropores (between 50 nm and 1.8 μm) is bipopulated, i.e. two pore distribution maxima are observed at 90 nm and 662 nm. The particles are thus both mesoporous and macroporous.

The oxygen carrier solid according to this example was aged under the conditions described in example 1.

FIG. 2C is a graph representing the normalized degree of conversion Xc of methane as a function of the number N of redox cycles in a CLC process using the oxygen carrier solid according to example 2. Methane conversion is about 86% at the beginning of the test, and the activity of the oxygen carrier decreases rapidly as the number of cycles increases, stabilizing around 43% after 250 cycles.

SEM (scanning electron microscopy) backscattered electron images on powder and on polished section of the particles after testing, as can be seen in FIG. 2D (images on the left at ×100 magnification and images on the right at ×250 magnification), show that the pore size and the associated pore volume are larger than those of the particles before the test. In addition, it is observed that the iron has migrated to the outside of certain particles, leading to a risk of agglomeration of the particles.

The significant increase in pore volume and pore size is confirmed by mercury porosimetry, as can be seen in FIG. 2E, which represents the volume of mercury injected Vi (ml/g) into the porosity as a function of the pore diameter (median diameter in nm), along with the ratio dV/dD (derivative of the (volume of Hg introduced/pore size)). The oxygen carrier after 250 redox cycles is exclusively macroporous (absence of pores with a diameter <50 nm), and the total (macro)pore volume measured by mercury porosimetry of the oxygen carrier after 250 redox cycles is 0.791 ml/g (+35%).

### Example 3: Carrier Solid Containing Fe₂O₃ (25% by Weight)/Stoichiometric MgAl₂O₄(75% by Weight), Y=21.25% by weight (not in accordance)

According to this example 3, an oxygen carrier solid is formed by adding 25% by weight of Fe₂O₃ to a stoichiometric spinel MgAl₂O₄.

The contents of Fe₂O₃, MgO and Al₂O₃ are such during the preparation that a stoichiometric spinel MgAl₂O₄ is formed.

In this Example 3, the particles of the oxygen carrier solid are prepared by dry impregnation of iron nitrate on a stoichiometric spinel MgAl₂O₄. The stoichiometric spinel is prepared by two successive dry impregnations of magnesium nitrate on the same alumina particles as those from example 2.

200 g of alumina particles thus obtained are dry-impregnated a first time with 190 ml of a 700 g/l solution of magnesium nitrate (Mg(NO₃)₂) and then dried at 120° C. for 12 hours and then calcined at 600° C. for 4 hours. A second dry impregnation of these particles with the same solution is then performed, followed by drying at 120° C. and calcination at 800° C. for 4 h. The MgO content of the support particles is then 28.3%, and the XRD analysis shows that the support consists of MgAl₂O₄.

Two successive dry impregnations of the spinel with a 990 g/l iron nitrate solution are then carried out, with intermediate calcination at 600° C., then final calcination at 900° C. for 12 h, making it possible to obtain particles containing about 25% by weight of Fe₂O₃ and 75% of MgAl₂O₄, i.e. 25% Fe₂O₃, 21.3% MgO and 53.7% Al₂O₃. The XRD analysis confirms the predominant presence of hematite Fe₂O₃ and the stoichiometric spinel MgAl₂O₄.

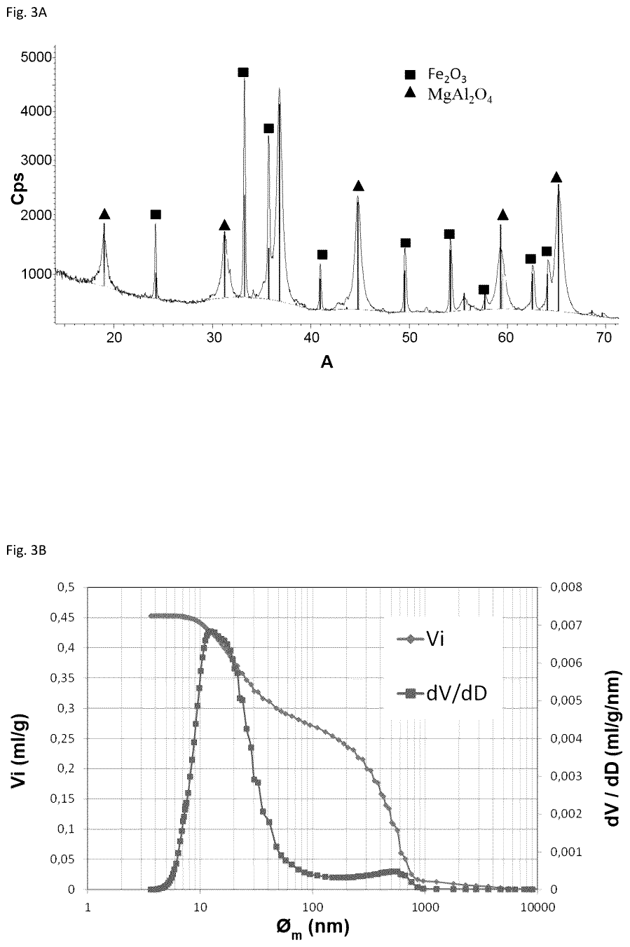

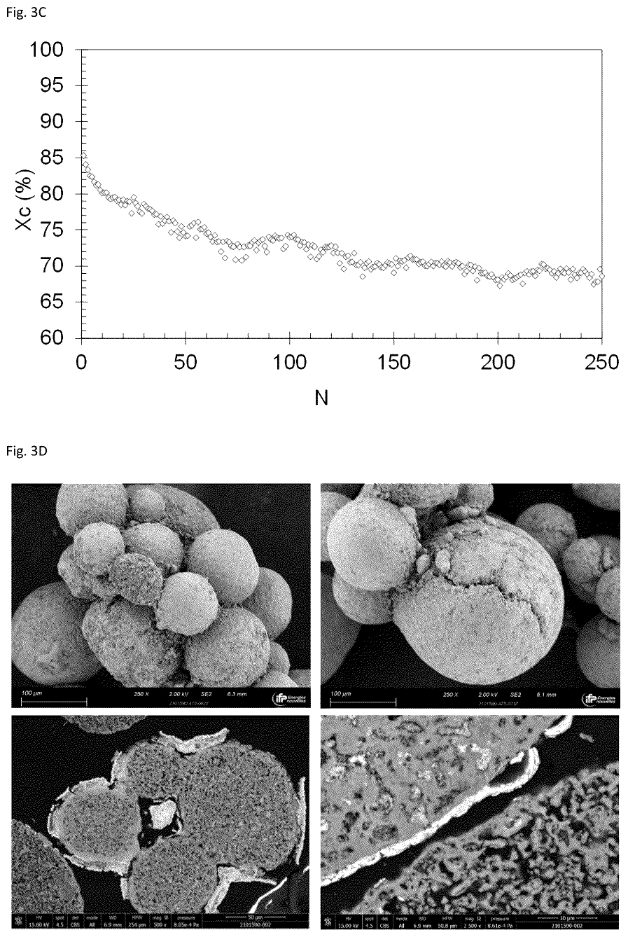

In the X-ray diffractogram of FIG. 3A, the abscissa A corresponds to the angle 2θ (in degrees) and the ordinate Cps represents the number of counts during the measurement.

The particle pore volume of the solid obtained, measured by mercury porosimetry, is 0.453 ml/g, of which 0.300 ml/g (i.e. 65.5% of the total pore volume measured by mercury porosimetry) is due to the macroporosity. The mesopore size distribution is between 4 and 50 nm and centered on 12.55 nm, as may be seen in the graph in FIG. 3B showing the volume of mercury injected Vi (ml/g) into the porosity as a function of the pore diameter (nm), along with the ratio dV/dD (derivative of the (volume of Hg introduced/pore size)), giving information regarding the pore size distribution for the oxygen carrier solid in this example. The macropore size distribution is greater than 50 nm and less than or equal to 2.8 μm and centered at 569 nm, as can be seen in the graph in FIG. 3B, which represents the volume of mercury injected Vi (ml/g) into the porosity as a function of the pore diameter (median diameter in nm), along with the ratio dV/dD (derivative of the (volume of Hg introduced/pore size)). The particles are thus both mesoporous and macroporous.

The nitrogen adsorption isotherm of the oxygen carrier solid according to this example makes it possible to measure a specific surface area of 43 m²/g, a micropore volume (pores <2 nm) of zero and a mesopore volume (2 nm<pores and 50 nm) of 0.204 ml/g.

The oxygen carrier solid according to this example was aged under the conditions described in example 1.

FIG. 3C is a graph representing the normalized degree of conversion Xc of methane as a function of the number N of redox cycles in a CLC process using the oxygen carrier solid according to example 3. The methane conversion is 85% at the start of the test and gradually decreases to about 69% after 250 cycles. Compared to example 2, the deactivation of the active phase is slower in the presence of the MgAl₂O₄ support.

However, SEM (scanning electron microscopy) backscattered electron images on powder and on polished section of the particles after testing, as can be seen in FIG. 3D (top images at ×250 magnification and images on the bottom left at ×500 magnification and on bottom right at ×2500 magnification), show that many particle agglomerates are formed during the test. The particles within these agglomerates are bound together by iron oxide (lighter phase on the polished section images) which migrated to the outside of the particles during successive redox cycles.

Example 3 shows that an oxygen carrier consisting of 25% Fe₂O₃ and 75% of an MgAl₂O₄ stoichiometric spinel ceramic matrix cannot be used in a chemical looping combustion process because the risk of defluidization related to particle agglomeration is high.

### Example 4: Carrier Solid Containing Fe₂O₃(25% by Weight)/Sub-Stoichiometric Mg_{0.239}Al_{2.508}O₄ (75% by Weight), X=25%, Y=5.25% by Weight, Calcined at 900° C. (in Accordance)

According to this example 4, an oxygen carrier solid is formed by adding 25% by weight of Fe₂O₃ to a sub-stoichiometric spinel with a theoretical formulation Mg_{0.239}Al_{2.508}O₄.

In this example 4, the particles of the oxygen carrier solid are prepared by dry impregnation of iron nitrate on a sub-stoichiometric spinel Mg_{0.239}Al_{2.508}O₄. The sub-stoichiometric spinel is prepared by a dry impregnations of magnesium nitrate on the same alumina particles as those from example 2.

200 g of alumina particles thus obtained are dry-impregnated with 190 ml of a 389 g/l solution of magnesium nitrate (Mg(NO₃)₂) and then dried at 120° C. for 12 hours and then calcined at 800° C. for 4 hours. The composition of the support is then 7% MgO, 93% Al₂O₃, in the form ofa sub-stoichiometric spinel with a theoretical formulation Mg_{0.239}Al_{2.508}O₄.

Two successive dry impregnations of the sub-stoichiometric spinel with a 990 g/l iron nitrate solution are then carried out, with intermediate calcination at 600° C., then final calcination at 900° C. for 12 h, making it possible to obtain particles containing about 25% by weight of Fe₂O₃ and 75% of Mg_{0.239}Al_{2.508}O₄, i.e. 25% Fe₂O₃, 5.25% MgO and 69.75% Al₂O₃.

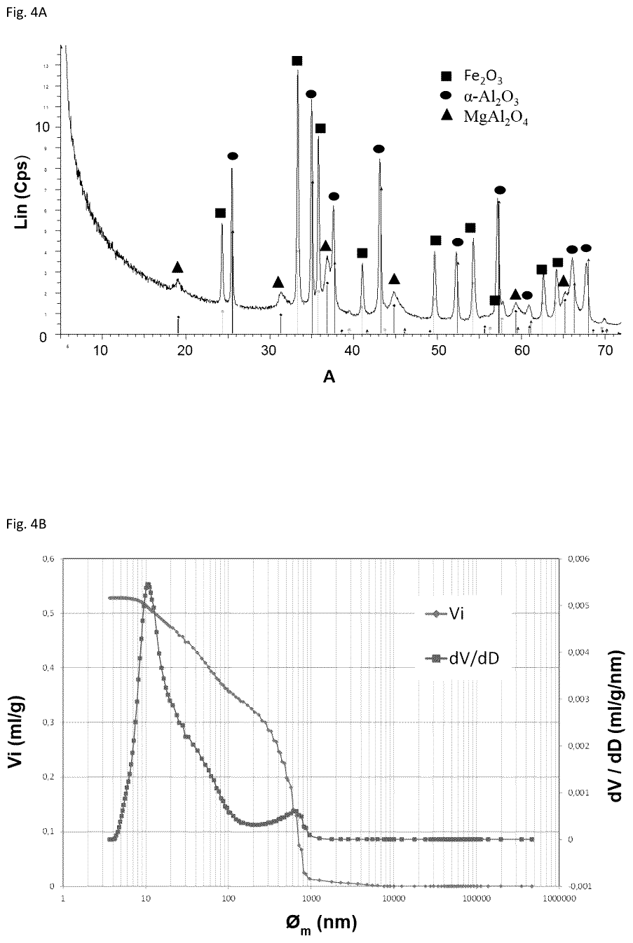

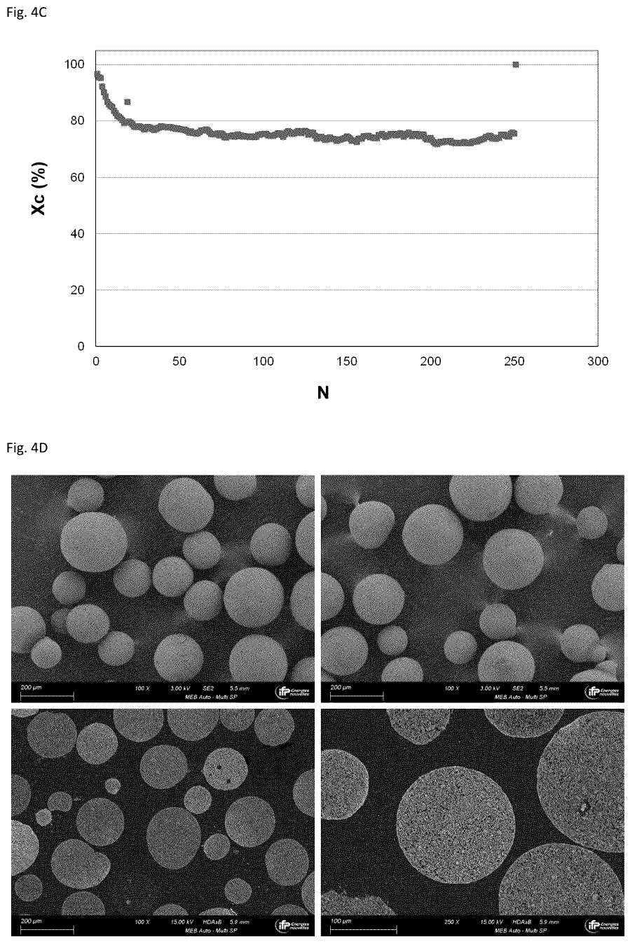

The XRD analysis indicates that after calcination at 900° C., the oxygen carrier solid is composed of hematite (Fe₂O₃), a sub-stoichiometric spinel of MgₐAl_{b}O₄ type (the lines due to the spinel are broad and shifted toward large angles) and alpha-alumina. In the X-ray diffractogram of FIG. 4A, the abscissa A corresponds to the angle 2θ (in degrees) and the ordinate Cps represents the number of counts during the measurement.

The pore volume of the particles of the solid obtained, measured by mercury porosimetry, is 0.528 ml/g, of which 0.409 ml/g (i.e. 77.5% of the total pore volume measured by mercury porosimetry) is due to the macroporosity, as can be seen in the graph in FIG. 4B showing the volume of mercury injected Vi (ml/g) into the porosity as a function of the pore diameter (nm), along with the ratio dV/dD (derivative of the (volume of Hg introduced/pore size)), giving information regarding the pore size distribution for the oxygen carrier solid in this example. The macropore size distribution is greater than 50 nm and less than or equal to 4 μm and centered at 663 nm, as may be seen in the diagram in FIG. 4B. The particles are thus both mesoporous and macroporous.

The oxygen carrier solid according to this example was aged under the conditions described in example 1.

FIG. 4C is a graph representing the normalized degree of conversion Xc of methane as a function of the number N of redox cycles in a CLC process using the oxygen carrier solid according to example 4. The methane conversion is approximately 99% at the beginning of the test. A rapid deactivation is observed during the first 20 cycles, the conversion decreasing to 80%, then deactivation with respect to methane conversion becomes very slow, and the final conversion of methane to CO₂+H₂O is still 75% after 250 cycles. Compared to example 3, when iron oxide is supported on a sub-stoichiometric spinel, the deactivation of the oxygen carrier is minimized compared to iron oxide supported on the stoichiometric spinel MgAl₂O₄. In addition, the SEM (scanning electron microscopy) backscattered electron images on powder and on polished section of the particles after testing, as can be seen in FIG. 4D (top images at ×100 magnification and images on the bottom left at ×100 magnification and on bottom right at ×250 magnification), show that the particles have not agglomerated during the test, and that the iron oxide has not migrated to the outside of the particles.

### Example 5: Carrier Solid Containing Fe₂O₃ (25% by Weight)/Sub-Stoichiometric Mg_{0.483}Al_{2.345}O₄(75% by Weight), Y=10.5% by Weight, Calcined at 900° C. (in Accordance)

According to this example 5, an oxygen carrier solid is formed by adding 25% by weight of Fe₂O₃ to a sub-stoichiometric spinel with a theoretical formulation Mg_{0.483}Al_{2.345}O₄.

In this example 5, the particles of the oxygen carrier solid are prepared by dry impregnation of iron nitrate on a sub-stoichiometric spinel Mg_{0.483}Al_{2.345}O₄. The sub-stoichiometric spinel is prepared by a dry impregnation of magnesium nitrate on the same alumina particles as those from example 2.

200 g of alumina particles thus obtained are dry-impregnated with 190 ml of a 780 g/l solution of magnesium nitrate (Mg(NO₃)₂) and then dried at 120° C. for 12 hours and then calcined at 800° C. for 4 hours. The composition of the support is then 14% MgO, 86% Al₂O₃, in the form ofa sub-stoichiometric spinel with a theoretical formulation Mg_{0.483}Al_{2.345}O₄.

Two successive dry impregnations of the sub-stoichiometric spinel with a 990 g/l iron nitrate solution are then carried out, with intermediate calcination at 600° C., then final calcination at 900° C. for 12 h, making it possible to obtain particles containing about 25% by weight of Fe₂O₃ and 75% of Mg_{0.483}Al_{2.345}O₄, i.e. 25% Fe₂O₃, 10.5% MgO and 64.5% Al₂O₃. The XRD analysis indicates that after calcination at 900° C., the oxygen carrier solid is composed of hematite (Fe₂O₃), a sub-stoichiometric spinel of MgₐAl_{b}O₄ type (the lines due to the spinel are broad and shifted toward large angles) and alpha-alumina.

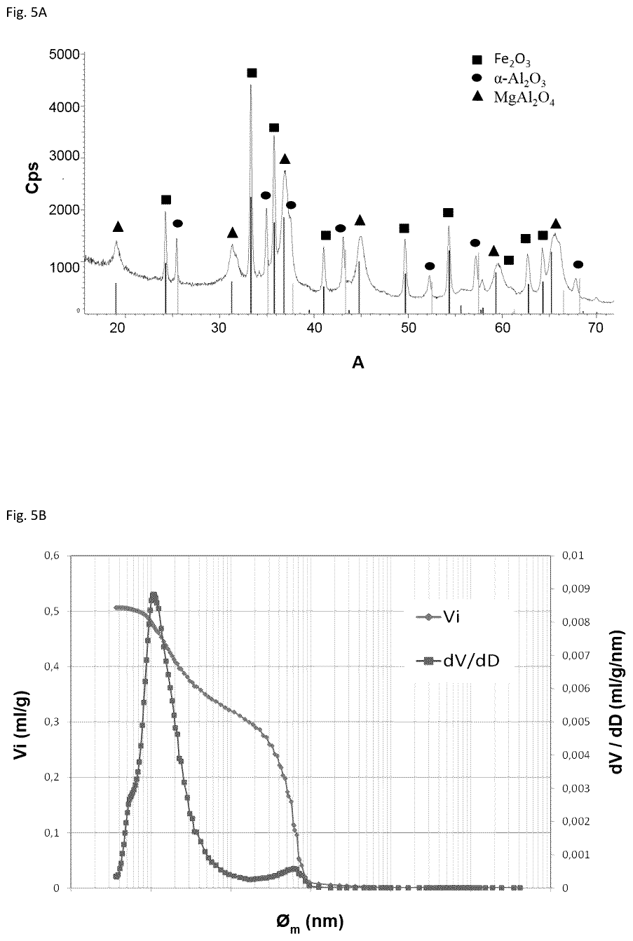

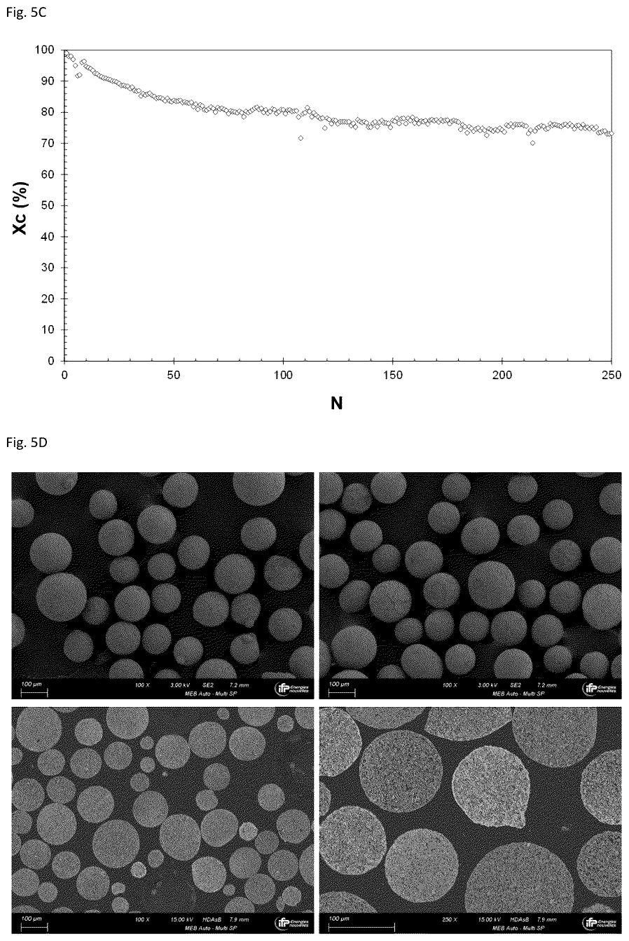

In the X-ray diffractogram of FIG. 5A, the abscissa A corresponds to the angle 2θ (in degrees) and the ordinate Cps represents the number of counts during the measurement.

The pore volume of the particles of the solid obtained, measured by mercury porosimetry, is 0.506 ml/g, of which 0.345 ml/g (i.e. 68.2% of the total pore volume measured by mercury porosimetry) is due to the macroporosity, as can be seen in the graph in FIG. 5B showing the volume of mercury injected Vi (ml/g) into the porosity as a function of the pore diameter (nm), along with the ratio dV/dD (derivative of the (volume of Hg introduced/pore size)), giving information regarding the pore size distribution for the oxygen carrier solid in this example. The macropore size distribution is greater than 50 nm and less than or equal to 4 μm and centered at 670 nm, as may be seen in the graph in FIG. 5B. The particles are thus both mesoporous and macroporous.

The oxygen carrier solid according to this example was aged under the conditions described in example 1.

FIG. 5C is a graph representing the normalized degree of conversion Xc of methane as a function of the number N of redox cycles in a CLC process using the oxygen carrier solid according to example 5. As in example 4, the methane conversion is approximately 99% at the beginning of the test. The deactivation is observed to be relatively slow, with the conversion of methane to CO₂+H₂O gradually decreasing to 74% at 250 cycles. Compared to example 4, when the iron oxide is supported on a sub-stoichiometric spinel containing twice as much MgO, the deactivation of the oxygen carrier is slower. As in example 4, the SEM (scanning electron microscopy) backscattered electron images on powder and on polished section of the particles after testing, as can be seen in FIG. 5D (top images at ×100 magnification and images on the bottom left at ×100 magnification and on bottom right at ×250 magnification), show that the particles have not agglomerated during the test, and that the iron oxide has not migrated to the outside of the particles.

### Example 6: Carrier Solid Containing Fe₂O₃(13% by Weight)/Sub-Stoichiometric Mg_{0.732}Al_{2.178}O₄(87% by Weight), Y=18.3% by Weight, Calcined at 900° C. (in Accordance)

According to this example 6, an oxygen carrier solid is formed by adding 13% by weight of Fe₂O₃ to a sub-stoichiometric spinel with a theoretical formulation Mg_{0.732}Al_{2.178}O₄.

In this example 6, the particles of the oxygen carrier solid are prepared by dry impregnation of iron nitrate on a sub-stoichiometric spinel Mg_{0.732}Al_{2.178}O₄. The sub-stoichiometric spinel is prepared by a dry impregnation of magnesium nitrate on the same alumina particles as those from example 2.

200 g of alumina particles thus obtained are dry-impregnated a first time with 190 ml of a 700 g/I solution of magnesium nitrate (Mg(NO₃)₂) and then dried at 120° C. for 12 hours and then calcined at 600° C. for 4 hours. A second dry impregnation of these particles with the same solution is then performed, followed by drying at 120° C. and calcination at 800° C. for 4 h. The MgO content of the support particles is then 21%.

A dry impregnation of the sub-stoichiometric spinel with a 990 g/l iron nitrate solution is then carried out. Calcination at 900° C. for 12 h makes it possible to obtain particles containing around 13% by weight of Fe₂O₃ and 87% of Mg_{0.732}Al_{2.178}O₄, i.e. 13% Fe₂O₃, 18.3% MgO and 68.7% Al₂O₃.

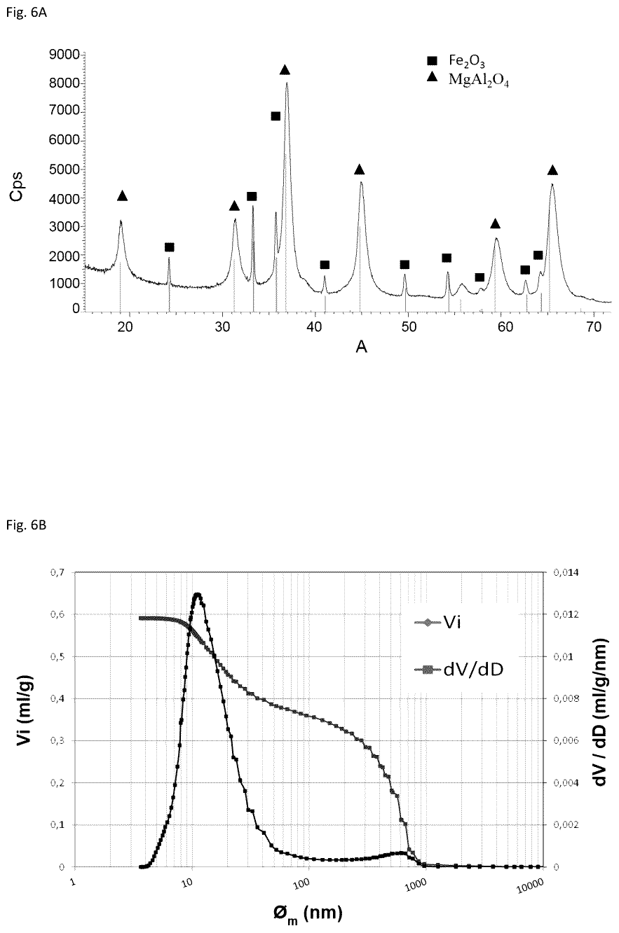

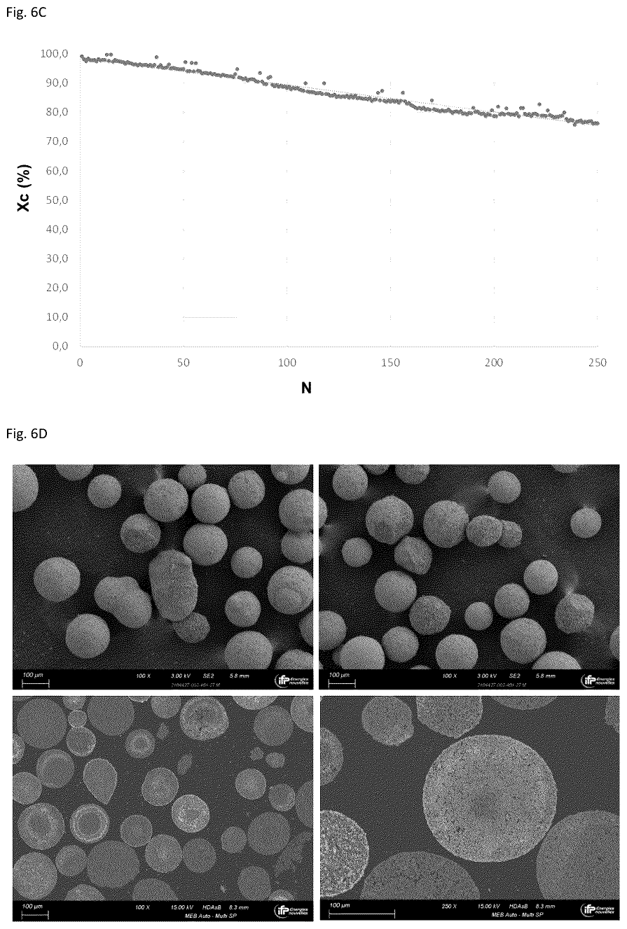

The XRD analysis indicates that after calcination at 900° C., the oxygen carrier solid is composed of a sub-stoichiometric spinel of MgₐAl_{b}O₄ type (the lines due to the spinel are broad and shifted toward large angles) and a mixed oxide close to Fe_{1.84}Al_{0.16}O₃. In the X-ray diffractogram of FIG. 6A, the abscissa A corresponds to the angle 2θ (in degrees) and the ordinate Cps represents the number of counts during the measurement.

The pore volume of the particles of the solid obtained, measured by mercury porosimetry, is 0.590 ml/g, of which 0.381 ml/g (i.e. 64.6% of the total pore volume measured by mercury porosimetry) is due to the macroporosity, as can be seen in the graph in FIG. 6B showing the volume of mercury injected Vi (ml/g) into the porosity as a function of the pore diameter (nm), along with the ratio dV/dD (derivative of the (volume of Hg introduced/pore size)), giving information regarding the pore size distribution for the oxygen carrier solid in this example. The macropore size distribution is greater than 50 nm and less than or equal to 4 μm and centered at 565 nm, as may be seen in the graph in FIG. 6B. The particles are thus both mesoporous and macroporous.

The oxygen carrier solid according to this example was aged under the conditions described in example 1, halving the reduction time in order to take into account the lower content of active phase in the oxygen carrier of this example.

FIG. 6C is a graph representing the normalized degree of conversion Xc of methane as a function of the number N of redox cycles in a CLC process using the oxygen carrier solid according to example 6. As in examples 4 and 5, the methane conversion is approximately 99% at the beginning of the test. A relatively slow and linear deactivation is observed, with the conversion of methane to CO₂+H₂O gradually decreasing to 76% after 250 cycles.

The SEM (scanning electron microscopy) backscattered electron images on powder and on polished section of the particles after testing, as can be seen in FIG. 6D (top images at ×100 magnification and images on the bottom left at ×100 magnification and on bottom right at ×250 magnification), show that the particles have not agglomerated during the test, and that the iron oxide has not migrated to the outside of the particles.

1. An oxygen carrier solid in particulate form for a chemical looping octopus redox process such as chemical looping combustion, comprising, in the oxidized form thereof:
iron (Fe) in a content X of between 5% and 39.3% expressed by weight of Fe₂O₃ relative to the total weight of the oxygen carrier solid;
magnesium (Mg) in a content Y of between 3% and 21.5% expressed by weight of MgO relative to the total weight of the oxygen carrier solid;
aluminium (Al) in a content Z of between 57% and 92% expressed by weight of Al₂O₃ relative to the total weight of the oxygen carrier solid;
with Y≤28.33-0.645X, the sum of the contents X, Y and Z being equal to 100%;
an active redox mass comprising Fe₂O₃;
a ceramic matrix within which said active redox mass is dispersed, said ceramic matrix comprising a substoichiometric spinel of formula MgₐAl_{b}O₄,
with:
$$a = \frac{4}{( 1 + ( 3 \times ( \frac{( 100 - X )}{Y} - 1 ) \times \frac{{M}_{MgO}}{{M}_{Al 2 O 3}} ) )}$$
$$b = \frac{8 \times ( 100 - X - Y )}{( Y \times \frac{{M}_{Al 2 O 3}}{{M}_{MgO}} + 3 \times ( 100 - X - Y ) )}$$
M_{MgO} and M_{Al2O3} being the respective molar masses of MgO and Al₂O₃.

2. The solid as claimed in claim 1, wherein the ceramic matrix further comprises alpha-alumina (α-Al₂O₃).

3. The solid as claimed in claim 1, wherein the Fe content X is between 20% and 39%, preferably between 25% and 35% expressed by weight of iron oxide relative to the total weight of the oxygen carrier solid in the oxidized form thereof.

4. The solid as claimed in claim 1, wherein the Fe content X is between 5% and 25%, preferably between 5% and 19% expressed by weight of iron oxide relative to the total weight of the oxygen carrier solid in the oxidized form thereof.

5. The solid as claimed in claim 1, wherein the particles have a substantially spherical shape, and a particle size such that more than 90% of the particles have a size of between 50 μm and 600 μm, preferably between 80 μm and 400 μm, and more preferentially between 100 μm and 300 μm.

6. The solid as claimed in claim 1, also having:
a total pore volume of the oxygen carrier solid Vtot, measured by mercury porosimetry, of between 0.05 and 1.2 ml/g;
a pore volume of the macropores constituting at least 10% of Vtot;
a size of the macropores within the oxygen carrier solid, measured by mercury porosimetry, of greater than 50 nm and less than or equal to 7 μm.

7. A process for preparing an oxygen carrier solid as claimed in claim 1, comprising the following steps:
(A) preparing an aqueous suspension comprising alumina particles and an aluminic binder, said aluminic binder preferably being boehmite and/or aluminum hydroxides, said alumina particles forming grains with a size of between 0.1 μm and 20 μm;
(B) spray-drying the suspension obtained in step (A) to form particles, said spray-drying involving spraying the suspension into a drying chamber with spraying means to form droplets, and simultaneously placing said droplets in contact with a hot carrier gas, preferably air or nitrogen, heated to a temperature of between 180° C. and 350° C.;
(C) calcining the particles resulting from the spray-drying in step (B), said calcining being performed in air and at a temperature of between 400° C. and 1400° C.;
(D) optional screening of the calcined particles obtained from step (C), preferably by separation using a cyclone;
(E) integrating Fe and Mg according to the sequence of steps (e1) and (e2), or according to step (e3), or according to steps (e3) and (e2) to produce the oxygen carrier solid in the form of particles:
(e1) (i) impregnating the calcined particles obtained from step (C) or optionally screened particles obtained from step (D) with an aqueous or organic solution containing at least one soluble Mg precursor compound, and then (ii) drying said impregnated particles obtained from (i) at a temperature of between 30° C. and 200° C., followed by (iii) calcination at a temperature of between 700° C. and 1400° C., preferably in air;
(e2) (j) impregnating the calcined particles obtained from step (e1) or the calcined particles obtained from step (C) or optionally the screened particles obtained from step (D), with an aqueous or organic solution containing at least one soluble Fe precursor compound and then (jj) drying said impregnated particles obtained from (j) at a temperature of between 30° C. and 200° C. followed by (jjj) calcination at a temperature of between 700° C. and 1400° C., preferably in air;
(e3) incorporating an Mg precursor and optionally an Fe precursor before step (B) according to one of the following sub-steps (k), (kk) or (kkk):
(k) before step (A), impregnating the alumina particles used for preparing the suspension in step (A) with an aqueous or organic solution containing at least one Mg precursor compound, and optionally an Fe precursor compound, optionally followed by drying the impregnated alumina particles at a temperature of between 30° C. and 200° C. and calcining the dried alumina particles at a temperature of between 700° C. and 1400° C., preferably in air;
(kk) after step (A) and before step (B), adding at least one soluble Mg precursor, and optionally a soluble Fe precursor, to the suspension obtained from step (A);
(kkk) after step (A) and before step (B), adding to the suspension obtained from step (A) at least one Mg oxide, and optionally an Fe oxide, said oxide(s) being in the form of grains with a size of between 0.1 μm and 20 μm;
it being understood that step (e2) is necessarily performed in combination with step (e3) if no Fe precursor compound or soluble Fe precursor compound or Fe oxide is added during sub-steps (k), (kk) and (kkk) in step (e3).

8. The preparation process as claimed in claim 7, wherein the calcination in step (C) and/or in step (e1)(iii) and/or in step (e2)(jjj) and/or in step (e3)(k) is performed for a period of 1 to 24 hours, and preferably the calcination in step (C) is performed for a period of 3 to 6 hours or for a period of 5 to 15 hours, the calcination in step (e1)(iii) and/or in step (e3)(k) is performed for a period of 3 to 6 hours, and the calcination in step (e2)(jjj) is performed for a period of 5 to 15 hours.

9. The preparation process as claimed in claim 7, wherein the calcination in step (C) is performed in air at a temperature of between 800° C. and 950° C., and more preferentially between 900° C. and 950° C., the calcination in step (e1)(iii) and/or in step (e3)(k) is performed in air at a temperature of between 750° C. and 950° C., and the calcination in step (e2)(jjj) is performed in air at a temperature of between 900° C. and 950° C., and preferably the calcination in step (C) and/or step (e1)(iii) and/or step (e2)(jjj) and/or step (e3)(k) is performed according to a temperature increase ramp of between 1° C./min and 50° C./min to reach the given calcination temperature.

10. The preparation process as claimed in claim 7, wherein the impregnation in step (e1)(i) and/or step (e3)(k) is performed dry with an aqueous solution comprising magnesium nitrate.

11. The preparation process as claimed in claim 7, wherein the impregnation in step (e2)(j) is performed with an aqueous solution comprising iron nitrate.

12. The preparation process as claimed in claim 7, wherein the amounts of magnesium and iron precursors are calculated so that Y is between 3% and 21.5% and X is between 5% and 39.3%, with Y≤28.33-0.645X, so as to form the sub-stoichiometric spinel of formula MgₐAl_{b}O₄.

13. The preparation process as claimed in claim 7, wherein the integration of Fe and Mg is performed according to step (e3), and preferably according to sub-step (kkk) or according to sub-step (kk), wherein magnesium nitrate is added to the suspension obtained from step (A) as a soluble Mg precursor, and optionally iron nitrate is added as a soluble Fe precursor, and wherein the calcination in step (C) is performed in air at a temperature of between 800° C. and 950° C., and more preferentially between 900° C. and 950° C., and for a time of from 1 to 24 hours, preferably from 5 hours to 15 hours.

14. A process for chemical looping redox combustion of a hydrocarbon feedstock using an oxygen carrier solid as claimed in claim 1.

15. The process for chemical looping redox combustion of a hydrocarbon feedstock as claimed in claim 14, wherein the oxygen carrier solid circulates between at least one reduction zone and one oxidation zone both operating in a fluidized bed, the temperature in the reduction zone and in the oxidation zone being between 600° C. and 12θ0° C., preferably between 600° C. and 1100° C., and more preferentially between 800° C. and 1100° C.

16. A process for chemical looping redox combustion of a hydrocarbon feedstock using an oxygen carrier solid prepared according to the process as claimed in claim 7.
